(19) United States
(12) Patent Application Publication
(10) Pub. No.: US 2013/0171401 A1
(43) Pub. Date: Jul. 4, 2013

(54) MESO-SCALE CARBON NANOTUBE SELF-ASSEMBLED TUBE STRUCTURES

(71) Applicants: Charles P. Marsh, Urbana, IL (US); Thomas A. Carlson, Champaign, IL (US); Peter B. Stynoski, Urbana, IL (US); Benjamin Ulmen, Urbana, IL (US)

(72) Inventors: Charles P. Marsh, Urbana, IL (US); Thomas A. Carlson, Champaign, IL (US); Peter B. Stynoski, Urbana, IL (US); Benjamin Ulmen, Urbana, IL (US)

(21) Appl. No.: 13/532,759

(22) Filed: Jun. 25, 2012

Related U.S. Application Data
(60) Provisional application No. 61/500,686, filed on Jun. 24, 2011.

(51) Int. Cl. C01B 31/02; C01B 31/00

(52) U.S. Cl. CPC C01B 31/0226; C01B 31/00; B82Y 40/00
USPC 428/47; 423/447.2; 427/600; 428/292.1; 977/742; 977/843

(57) ABSTRACT

Multiple-scale self-assembled tube structures (SATS) comprising multiwall carbon nanotubes (CNT) and processes for their nucleation and growth. These hierarchical and self-assembled SATS demonstrate the feasibility of controlled synthesis of macroscopic CNT structures and CNT-reinforced materials for use in broad applications such as structures, thermal transfer, electronics, fluid dynamics, and micro-fluidics.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees. Please contact Bea Shahin at 217 373-7234.

### BACKGROUND

Discovery of carbon nanotubes (CNTs) in 1991 is usually attributed to Iijima, although earlier work may have suggested their existence. Iijima, S., Helical Microtubules of Graphitic Carbon, Nature 354 (6348), 56-58, 1991; Monthioux, M. & V. L. Kuznetsov, Who Should Be Given the Credit for the Discovery of Carbon Nanotubes? Carbon 44 (9), 1621-1623, 2006; Radushkevich, L. V. & V. M. Lukyanovich, O Strukture Ugleroda, Obrazujucegosja pri Termiceskom Razlozenii Okisi Ugleroda na Zeleznom Kontakte, Zurn. Fisic. Chim. 26, 88-95, 1952; Hillbert, M. & N. Lange, The Structure of Graphite Filaments, Z Kristalloger 111, 24, 1958; Baker, R. T. K. et al., Formation of Filamentous Carbon from Iron, Cobalt and Chromium Catalyzed Decomposition of Acetylene, J. Catal 30, 86-95, 1973; Endo, M., University of Orleans, France, 1975; Oberlin, A., et al., Filamentous Growth of Carbon Through Benzene Decomposition, Journal of Crystal Growth 32 (3), 335-349, 1976.

In particular, Oberlin et al. show detailed Transmission Electron Microscopy (TEM) images, detail a mono-crystalline central tube of diameter 20-500 Å, and propose an iron catalyst based growth mechanism to form a hollow tube. There is even strong evidence, presumably unknown at the time, that Damascus steel contains CNTs. Reibold, M. et al., Materials: Carbon Nanotubes in an Ancient Damascus Sabre, Nature 444 (7117), 286-286, 2006. 25

In addition to numerous other properties of interest, carbon nanotubes (CNTs) are seen as the basis for new materials of extraordinary strength based mainly upon the very high carbon-carbon bond energies and their unique tubular structure at the molecular scale. Welch, C. R., Marcuson, W. F., & I. Adiguzel, Will Super-molecules and Supercomputers Lead to Super Construction Materials? Civil Engineering, November, 42-53, 2008; Barrow, G. M., Physical Chemistry, 4th ed. McGraw-Hill Book Company, New York, 1979. As well, in the area of materials development, the guiding concept of bio-inspired hierarchical structures combined with controlled fabrication at multiple scales may result in significantly improved mechanical performance.

Recently associated with CCVD, the use of silicon single-crystal growth substrates yielded interesting results for CNT synthesis. Chen, Y. & J. Yu, Patterned Growth of Carbon Nanotubes on Si Substrates without Pre-Deposition of Metal Catalysts, Applied Physics Letters 87 (3), 033103, 2005.

Typically, growth of conventional CNTs associated with a scribed substrate region is reported, and some researchers, for their specific conditions, state that growth is not possible on the polished (and un-prepared) side of a silicon (Si) (111) wafer. Fan, S., et al., Carbon Nanotube Arrays on Silicon Substrates and their Possible Application, Physica E: Low-dimensional Systems and Nanostructures 8 (2), 179-183, 2000; Yu, J. & Y. Chen, San Francisco, Calif., 2006 (unpublished). Yue, Y. et al., Selecting the Growth Sites of Carbon Nanotubes on Silicon Substrates by Ion Implantation, Applied Physics Letters 88 (26), 263115-263113, 2006.

A type of doublet tube form has been reported, but this is not made of CNTs. Reches, M. & E. Gazit, Controlled Patterning of Aligned Self-Assembled Peptide Nanotubes, Nat Nano 1 (3), 195-15 200, (2006). There are, however, Scanning Electron Microscope (SEM) images available on the internet of CNT growth on Silicon 28, some of which could be interpreted as SATS although descriptive detail is lacking. Hart, J., Nanobliss: Self-Organized and Lithographically-Patterned Architectures, available at nanobliss.com/depaitments/architectures/selforganizedandpatterned/architectures_selforganizedandpatterned/index.html, 2007. In the realm of what has been merely envisioned and modeled, various examples exist. One computer simulation in particular examines a larger CNT-like tube structure that is itself made of CNTs. Coluci, V. R., et al., Geometric and Electronic Structure of Carbon Nanotube Networks: ‘Super’-Carbon Nanotubes, Nanotechnology 3, 2006.

Purposefully fabricated CNT assembly using external means is reported. For self assembly 25 in general see: Li, Y.-L., et al., Direct Spinning of Carbon Nanotube Fibers from Chemical Vapor Deposition Synthesis, Science 304 (5668), 276-278, 2004; Zhang, M., et al., Multifunctional Carbon Nanotube Yarns by Downsizing an Ancient Technology, Science 306 (5700), 1358-1361, 2004; Vigolo, B. et al., Macroscopic Fibers and Ribbons of Oriented Carbon Nanotubes, Science 290 (5495), 1331-1334, 2000; Li, Q. W. et al., Sustained Growth of Ultra-long Carbon Nanotube Arrays for Fiber Spinning, Advanced Materials 18 (23), 3160-3163, 2006; Ericson, L. M. et al., Macroscopic, Neat, Single-Walled Carbon Nanotube Fibers, Science 305 (5689), 1447-1450 2004; Koziol, K. et al., High-Performance Carbon Nanotube Fiber, Science 318 (5858), 1892-1895, 2007.

Related modeling (only) research includes innovative molecular dynamics-based design work for producing very strong structural CNT fiber. Haskins, R. W. et al., Tight-Binding Molecular Dynamics Study of the Role of Defects on Carbon Nanotube Moduli and Failure, The Journal of Chemical Physics 127 (7), 074708, 2007. Cornwell, Charles F. and Charles R. Welch, Very High Strength (60 GPa) Carbon Nanotube Fiber Design Based on Molecular Dynamics Simulations, J. of Chemical Physics, 134, 204708, 2011.

Select embodiments of the present invention include examples of a multi-millimeter scale Self-Assembled Tube Structure (SATS) grown on the polished side of a Si (111) wafer. Select ones of these multi-millimeter scale SATS are composed of multiwall CNTs (FIG. 43). Described herein are important aspects of the nucleation and growth of these SATS. These hierarchical structures facilitate the controlled synthesis of macroscopic CNT structures and CNT-reinforced materials for use in innovative general engineering applications, either singly or in combination, e.g., electronics, structures, thermal transfer, fluid dynamics, and micro-fluidics.

### BRIEF DESCRIPTION OF DRAWINGS

FIG. 1A is a line drawing of a silicon (Si) wafer prepared for CNT growth, showing only a CNT forest.

FIG. 1B is a line drawing of the silicon (Si) wafer of FIG. 1A prepared for CNT growth by incorporating large Si particles in the surface, showing clumped SATS in the CNT forest.

FIG. 1C is a line drawing of a silicon (Si) wafer of FIG. 1B prepared for CNT growth by 25 incorporating small Si particles in the surface as done for select embodiments of the present invention, showing both clumped and individual SATS in the CNT forest.

FIG. 2 is a schematic of a laboratory configuration used to grow the SATS of select embodiments of the present invention.

FIG. 3 depicts a temperature profile for a quartz reaction tube used in the laboratory configuration of FIG. 2.

FIG. 4 is a TEM image of a complete SATS structure.

FIG. 5 is a TEM image of the bulk layout within a complete SATS structure.

FIG. 6 is a TEM image of individual layouts within a complete SATS structure.

FIG. 7 is a close-up TEM image of an individual CNT within the complete SATS structure.

FIG. 8 shows profilometry data for the “rough” (un-polished) side of a cleaned Si wafer substrate.

FIG. 9 shows profilometry data for the “smooth” (polished) side of a cleaned Si wafer substrate.

FIG. 10 is a SEM image of a SATS after failing a tension test.

FIG. 11 is a SEM image of a hollow SATS that failed longitudinally from excess handling pressure.

FIG. 12 is a schematic of a laboratory configuration showing different placement of the substrates used to grow the SATS of select embodiments of the present invention.

FIG. 13 shows the tops of the SATS towers grown at the leading edge of the substrate for a first experimental condition, enlarged at 100×.

FIG. 14 is close-up of the tops of the SATS towers grown at the leading edge of the substrate for a first experimental condition, enlarged at 100×.

FIG. 15 is a perspective view of the SATS towers grown at the leading edge of the substrate for a first experimental condition, enlarged at 250×.

FIG. 16 shows a perspective view of the SATS towers grown at the midpoint of the substrate for a first experimental condition, enlarged at 100×.

FIG. 17 shows the tops of the SATS towers grown at the midpoint of the substrate for a first experimental condition, enlarged at 100×.

FIG. 18 shows the tops of the SATS towers grown at the midpoint of the substrate for a first experimental condition, enlarged at 500×.

FIG. 19 shows a close-up of the tops of the SATS towers grown at the midpoint of the substrate for a first experimental condition, enlarged at 5000×.

FIG. 20 is a perspective view of the SATS towers grown at the trailing edge of the substrate for a first experimental condition, enlarged at 30×.

FIG. 21 is an elevation view of the SATS towers grown at the trailing edge of the substrate for a first experimental condition, enlarged at 500×.

FIG. 22 is a perspective view of a broken off piece of SATS towers grown at the trailing edge of the substrate for a first experimental condition, enlarged at 150×.

FIG. 23 is a close-up of a broken off piece of SATS towers grown at the trailing edge of the substrate for a first experimental condition, enlarged at 1000×.

FIG. 24 shows pieces of iron among the SATS towers grown at the trailing edge of the substrate for 25 a first experimental condition, enlarged at 250×.

FIG. 25 shows the tops of the SATS towers grown at the leading edge of the substrate for a second experimental condition, enlarged at 250×.

FIG. 26 is an elevation view of the tops of the SATS towers grown at the leading edge of the substrate for a second experimental condition, showing the formation of cubes on each side of the tops of the towers enlarged at 250×.

FIG. 27 is an elevation view of the tops of the SATS towers grown at the leading edge of the substrate for a second experimental condition, showing the formation of cubes on each side of the tops of the towers enlarged at 500×.

FIG. 28 shows the tops of the SATS towers grown at the midpoint of the substrate for a second experimental condition, enlarged at 200×.

FIG. 29 shows the tops of the SATS towers grown at the midpoint of the substrate for a second experimental condition, enlarged at 250×.

FIG. 30 shows the tops of the SATS towers grown at the midpoint of the substrate for a second experimental condition, enlarged at 100×.

FIG. 31 shows a close-up of the tops of the SATS towers grown at the trailing edge of the substrate for a second experimental condition, enlarged at 1000×.

FIG. 32 shows the tops of the SATS towers grown at the trailing edge of the substrate for a second experimental condition, enlarged at 250×.

FIG. 33 shows the tops of the SATS towers grown at the leading edge of the substrate for a third experimental condition with some dislodged towers, enlarged at 75×. 25

FIG. 34 shows the tops of the SATS towers grown at the leading edge of the substrate with some partially grown towers for a third experimental condition, enlarged at 75×.

FIG. 35 shows the tops of the SATS towers grown at the leading edge of the substrate for a third experimental condition, enlarged at 250×.

FIG. 36 shows a close-up of the top of a SATS tower grown at the leading edge of the substrate for a third experimental condition, enlarged at 2500×.

FIG. 37 shows the tops of the SATS towers grown at the midpoint of the substrate for a third experimental condition, enlarged at 100×.

FIG. 38 shows the tops of the SATS towers grown at the trailing edge of the substrate for a third experimental condition, enlarged at 100×.

FIG. 39 shows a perspective view of the SATS towers grown at the trailing edge of the substrate for a third experimental condition, enlarged at 75×.

FIG. 40 shows the tops of the SATS towers grown at the trailing edge of the substrate for a third experimental condition, enlarged at 1000×.

FIG. 41 shows the surrounding rim of a dense, long CNT forest on the leading edge of the substrate that held together even as the underlying substrate cracked off while being removed from the quartz tube.

FIG. 42 shows the surrounding CNT forest rim on the leading edge of the substrate, with CNT length of approximately 1170 microns, enlarged at 200×.

FIG. 43A shows the “worm-like” structure, enlarged 60×, that erupted when the unpolished (rough) matte side of a (111) single-crystal silicon wafer was used as the substrate for growing CNTs.

FIG. 43B shows the end of the structure of FIG. 43A enlarged 430×.

FIG. 43C depicts the Raman spectra for a SATS, delineating the shift response in D and G bands that is indicative of CNTs.

FIG. 44A depicts a Si substrate that is cleaned in preparation for CNT growth.

FIG. 44B depicts a Si substrate that has been cleaned in preparation for CNT growth and had large Si dust particles added to the surface.

FIG. 44C depicts a Si substrate that has been cleaned in preparation for CNT growth and had small Si dust particles added to the surface.

FIG. 45A shows CNT forest growth on a cleaned Si (111) substrate with no Si dust particles deposited.

FIG. 45B is a SEM image of the substrate of FIG. 45A enlarged 100×, showing the CNT forest with no SATS growth.

FIG. 45C shows CNT forest growth and clumped SATS growth on a cleaned Si (111) substrate with large Si dust deposited.

FIG. 45D is a SEM image of the substrate of FIG. 45C enlarged 100×, showing the CNT forest with clumped SATS growth.

FIG. 45E shows CNT forest growth and individual SATS growth on a cleaned Si (111) substrate with small Si dust deposited.

FIG. 45F is a SEM image of the substrate of FIG. 45E enlarged 100×, showing the CNT forest with individual SATS growth.

FIG. 46A shows a line inscribed on a cleaned smooth side of a Si (111) substrate, enlarged 35×.

FIG. 46B is a SEM image of the substrate of FIG. 46A enlarged 50×, showing typical CNT forest growth.

FIG. 46C shows CNT forest growth and SATS growth along the scribed line on the substrate of FIG. 46A, enlarged at 10×.

FIG. 46D is a SEM image of a typical hole in the part of the CNT forest not associated with the scribed line on the substrate of FIG. 46C, enlarged at 500×.

### DETAILED DESCRIPTION

Select embodiments of the present invention employ a pyrolytic Catalytic Chemical Vapor Deposition (CCVD) technique. Hart, A. J. & A. H. Slocum, Rapid Growth and Flow-Mediated Nucleation of Millimeter-Scale Aligned Carbon Nanotube Structures from a Thin-Film Catalyst, Journal of Physical Chemistry B 110 (16), 8250-8257, 2006.

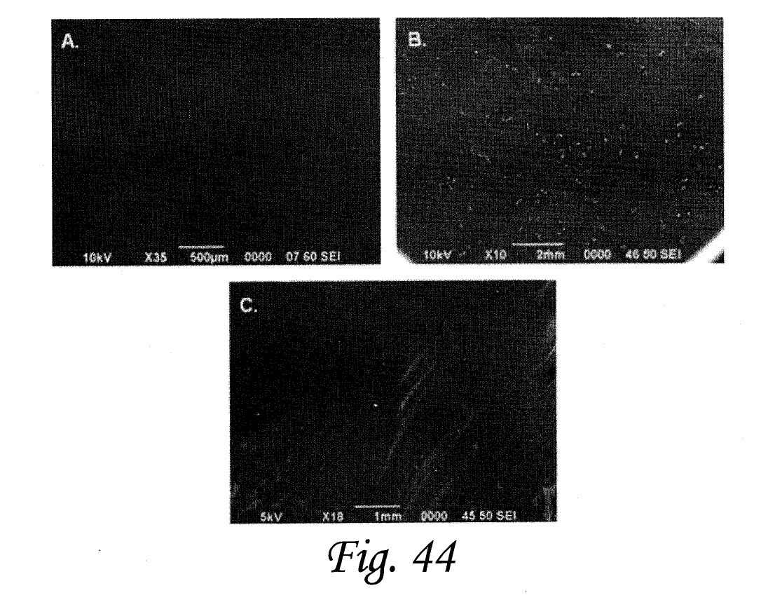

In association with CCVD, silicon single-crystal growth substrates have been used. Typically, growth of conventional CNTs is associated with a scribed substrate region. Chen Y. and J. Yu, Patterned Growth of Carbon Nanotubes on Si Substrates Without Pre-deposition of Metal Catalysts, Appl Phys Lett, 87(3):033103, 2005; Fan S. et al., Carbon Nanotube Arrays on Silicon Substrates and Their Possible Application, Physica E, 8(2):179-83, 2000; Yu J. and Y. Chen, “Scratching” Carbon Nanotubes onto Si Substrates, Materials Research Society Symposium, San Francisco, Calif., Materials Research Society, p. 55-60, 2006. Yue, Y. et al., Selecting The Growth Sites of Carbon Nanotubes on Silicon Substrates by Ion Implantation, Appl Phys Lett 88(26):263115-3, 2006. Some researchers, for specific conditions, state that growth is not possible on the polished and otherwise unprepared side of a silicon (Si) (111) wafer. Select embodiments of the present invention induce prolific growth localized to a scribed substrate region on silicon and grow CNTs on the polished side of a silicon (111) wafer. Select embodiments of the present invention yield structure by depositing on a clean Si substrate (see FIG. 44A) silicon particles (see FIGS. 44B and C) prior to CCVD growth. 25

In developing select embodiments of the present invention, a modified CCVD method was employed for multiple CNT growth experiments on Si (111) wafers to explore the effect of surface quality on growth behavior. Barreiro, A. et al., Thermal Decomposition of Ferrocene as a Method for Production of Single-Walled Carbon Nanotubes without Additional Carbon Sources, The Journal of Physical Chemistry B 110 (42), 20973-20977, 2006; Barreiro, A. et al., On The Effects of Solution and Reaction Parameters for the Aerosol-Assisted CVD Growth of Long Carbon Nanotubes, Applied Physics A: Materials Science & Processing 82 (4), 719-725, 2006.

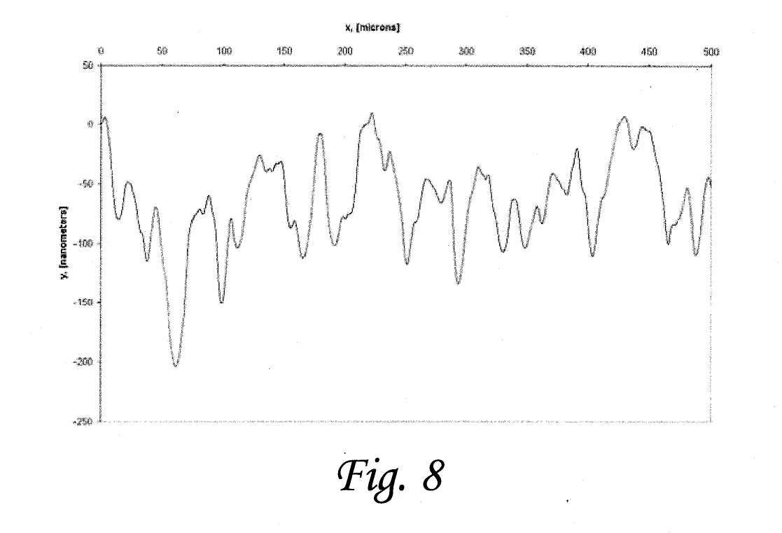

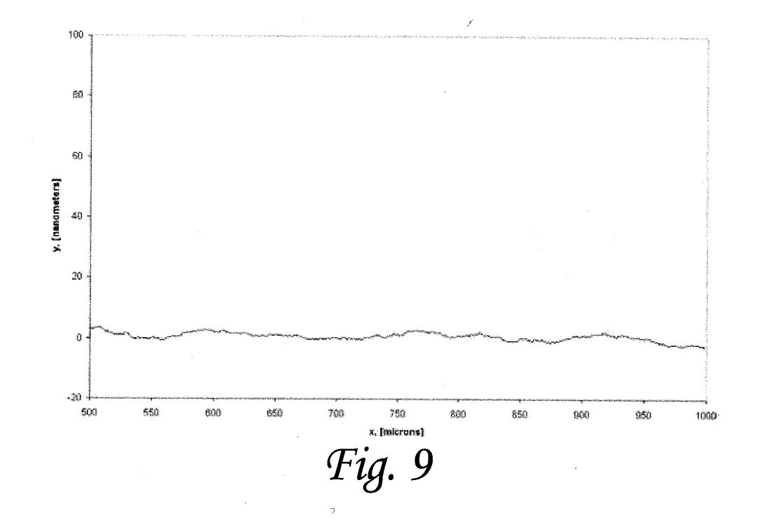

Single-crystal 10.2 cm silicon wafers with a (111) surface orientation were cut into approximately rectangular slides 100 using a diamond-tip scribe and straightedge. The narrower dimension was chosen to be approximately 25 mm in part for convenience of insertion into the fused quartz reaction tube 205. A wash sequence of acetone followed by methanol and then isopropanol was used to clean the substrate of any debris. Nel et al. (1998). Prior to silicon particle deposition and growth, the surface roughness of the silicon single-crystal surface was characterized via profilometry using a Sloan Dektak3 instrument. The profile of the matte side of the wafer is shown in FIG. 8. A 500 micron scan shows roughness that spans approximately 125 nm in the dimension perpendicular to the surface. Any single surface feature does not, however, appear to exceed approximately 50 microns in lateral extent parallel to the surface. The fact that the perpendicular features are approximately three orders of magnitude smaller than the lateral surface irregularities indicates surface topography varies only slightly. In comparison, the polished side of the silicon single crystal surface was also characterized by profilometry as shown in FIG. 9. A similar 500 micron scan (FIG. 9) shows considerably less roughness, i.e., approximately 5 nm perpendicular to the surface. This variation indicates a flatness within two orders of magnitude of atomic scale. Sample substrates 100 were left either in this clean state or deposited with silicon particles after cleaning.

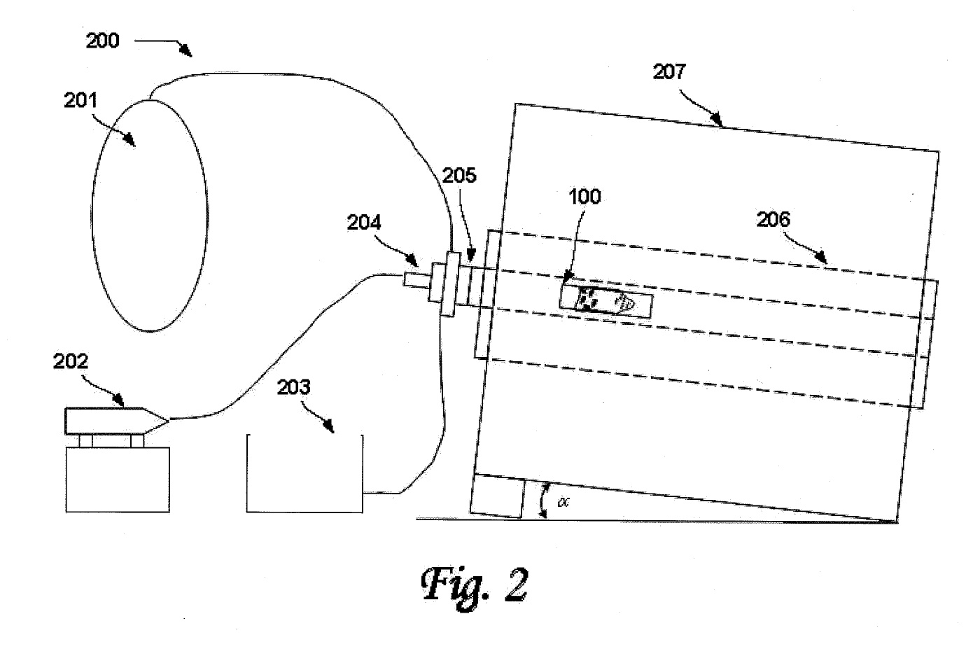

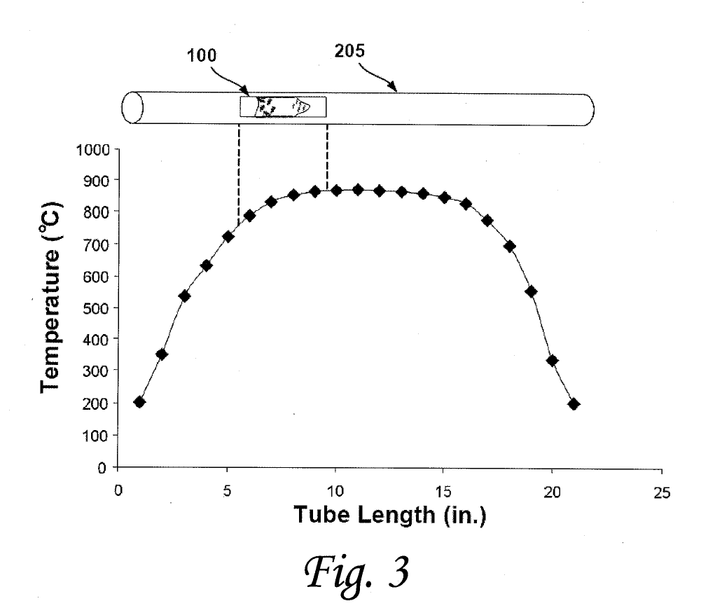

A 1.0% mol mixture of ferrocene powder in xylene was prepared and loaded into a glass syringe. Refer to FIG. 2. A fused quartz reaction tube 205 (610 mm length×35 mm inner diameter) was laid in a mullite process tube 206 inside a Lindberg 55320 tube furnace 207 inclined at an angle, a, of 10°. After placing the prepared substrate in the reaction tube 205 at the desired depth of 14.0 cm (5.5 in.) from the entrance of the quartz reaction tube 205, a ferrocene mixture and Ultra-High Purity (UHP) helium delivery apparatus 201 with a smooth nozzle was inserted into the 25 high end of the quartz tube 205. Helium flow was controlled at 1.0 SLPM for five minutes before setting the furnace to 875° C. Refer to FIG. 3 showing the temperature profile of the quartz reaction tube 205. Following a one-hour dwell time, a syringe pump 202 regulated the mixture flow at 0.500 mL/minute into a Sono-Tek 06-05108 ultrasonication nozzle 204 from an ultrasonic processor 203 running at 2.1 W and 120 kHz. After 26 mL of the mixture was dispensed, the pump 202 was halted and the furnace 207 was allowed to cool to 100° C. before stopping helium flow. Characterization of samples was performed using both SEM (JEOL JSM 6390) and TEM (JEOL 2010LaB6, single tilt stage, operated at 200 kV).

The silicon particles used in experiments were produced by abrading a Si (111) wafer sample. The particles were characterized by both SEM imaging and dynamic light scattering (DLS) techniques. The DLS instrument used was a Microtrac Nanotrac 150. Particles larger than 2.75 5 microns did not stay in suspension and were not recorded by the DLS instrument. The presumption by the DLS instrument of perfectly spherical particles undergoing Brownian motion also renders this characterization method as semi-quantitative for non-spherical morphologies. Particle separation was achieved using an electrostatically charged polypropylene sheet such as a lid to a silicon wafer carrier. In this manner a differential size separation was achieved, with the larger particles being removed.

To investigate the nucleation and growth mechanism, silicon particles were deposited in two different size ranges together with a control sample. In all experiments the Si (111) substrates were exposed to identical growth conditions. The sample position in the furnace was purposefully chosen to include a slight temperature gradient across the wafer, and this positioning was consistently employed. FIG. 3 shows the steady-state temperature profile of the furnace as well as the sample position. The temperature range across the silicon substrate was 750-850° C. The first substrate was a control, using a published cleaning protocol, and consisted of only the Si wafer. Nel, J. M. et al., Using Scanning Force Microscopy (SFM) to Investigate Various Cleaning Procedures of Different Transparent Conducting Oxide Substrates, Appl Surf Sci, 134(1-4), 22-30, 1998. Two wafers (FIGS. 44B and C), similarly prepared using the same cleaning procedure, had silicon particles of two different size classes deposited thereon. The larger size class (FIG. 44B) was measured to encompass particles 1-250 microns in diameter. The smaller silicon particle size class (FIG. 44C) was measured to encompass particles of 1-100 microns in diameter. FIGS. 44 A-C shows the three prepared substrates immediately prior to growth. Note the differing sized scale bars, especially 25 between FIGS. 44B and C.

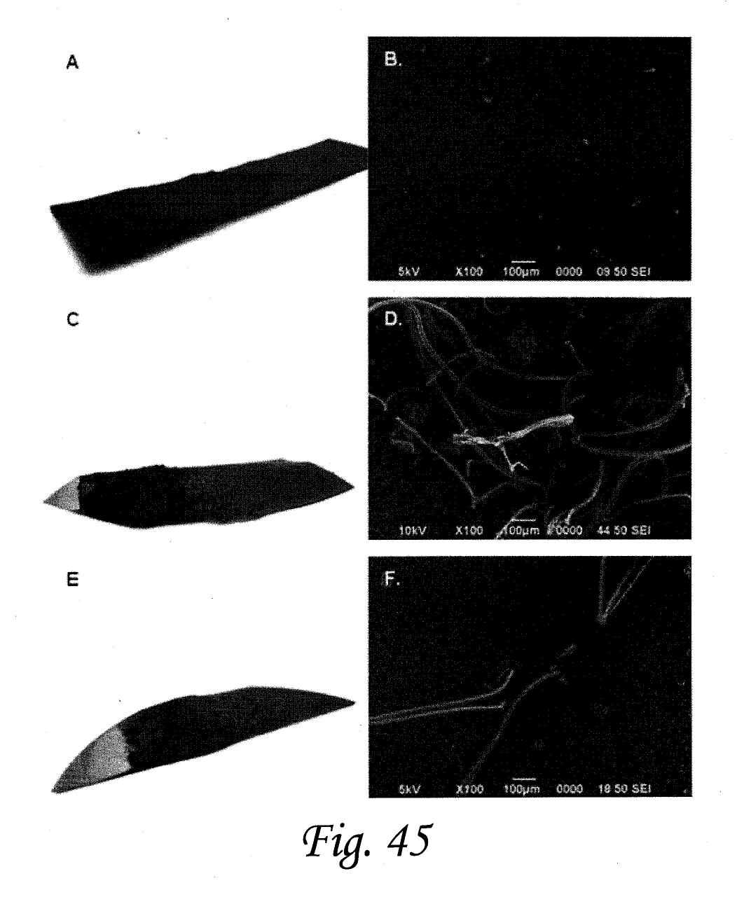

Refer to FIGS. 45A-F. Depositing large Si particles yielded clumped SATS growth (FIGS. 45C, D) on the CNT forest (shown by itself in FIGS. 45A, B) while small Si particles contributed individual SATS growth (FIG. 45E, F) on the CNT forest. The presence of CNTs was confirmed by Raman Spectroscopy and TEM imaging. Heller, D. A, et al., Using Raman Spectroscopy to Elucidate the Aggregation State of Single-Walled Carbon Nanotubes, The Journal of Physical Chemistry B 108 (22), 6905-6909, 2004. These new CNT structures erupted from the surface of the dense CNT forest growth (FIGS. 45A, B).

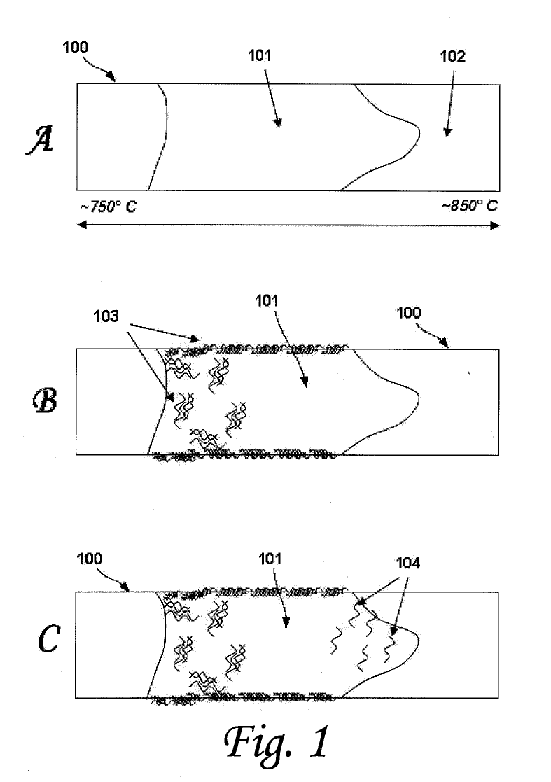

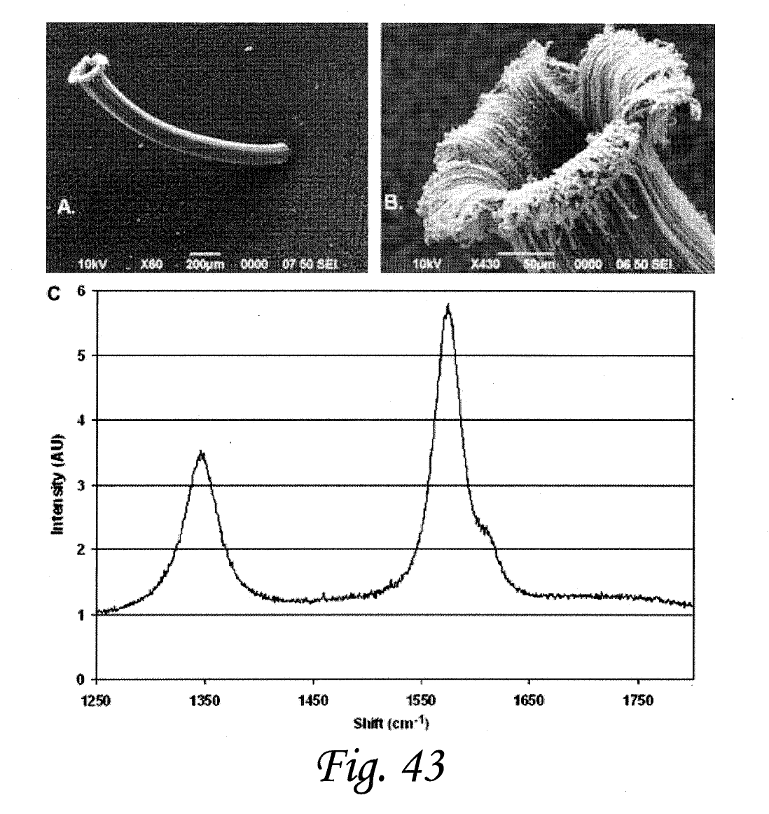

Refer to FIGS. 1A-C depicting the CNT growth regimes initially explored with just the unpolished (rough) matte side of a (111) single-crystal silicon wafer 100 as the substrate (FIG. 1A), then adding large Si particles (FIG. 1B) and finally small Si particles (FIG. 1C) to the substrate 100. Initially, a uniform and dense forest 101 of multiwall CNTs was produced on the unpolished side with no deposits of Si particles, as shown in FIG. 1A. This mode of growth had an additional feature that was not caused by any external alteration of experimental parameters: the formation of discrete and distributed worm-like structures (see FIG. 43A) that erupted from the dense forest 101. Their characterization was performed using scanning electron microscopy (SEM) (FIGS. 43A and B) and Raman spectroscopy (FIG. 43C). For FIGS. 43A and B 40° of tilt was used on the sample stage. Accounting for this alteration in perspective, the actual length of the grown SATS is approximately 3.0 mm. Upon close examination of the inner surface, an intermediate hierarchical structure of regular lateral ridges and larger longitudinal angular sections can be discerned. For FIG. 43C the sample was placed on a silicon chip. The conditions used for the Raman spectroscopy characterization were a laser wavelength of 532 nm set at a power of 44 mW and an exposure time of 600 sec. The D and G bands (FIG. 43C) shown are indicative of the presence of CNTs.

After growth, the control sample evidenced a uniform and dense multiwall CNT forest growth (FIGS. 45A and 45B). Some irregularities atop the forest can be observed, but they exhibit no particular or regular structure. In contrast, for the sample deposited with larger silicon particles, profusions of dense clumps of SATS structures formed along with individual SATS (FIGS. 45C and D). For the sample deposited with smaller silicon particles, fewer clumps of SATS were present, and more individual and more isolated SATS were formed (FIGS. 45E and F). These individual SATS grew to considerably greater lengths, up to approximately 3 mm.

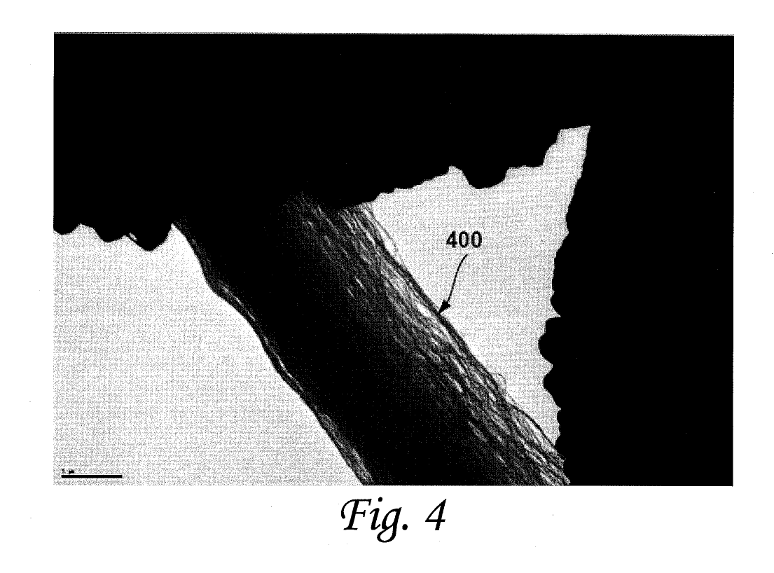

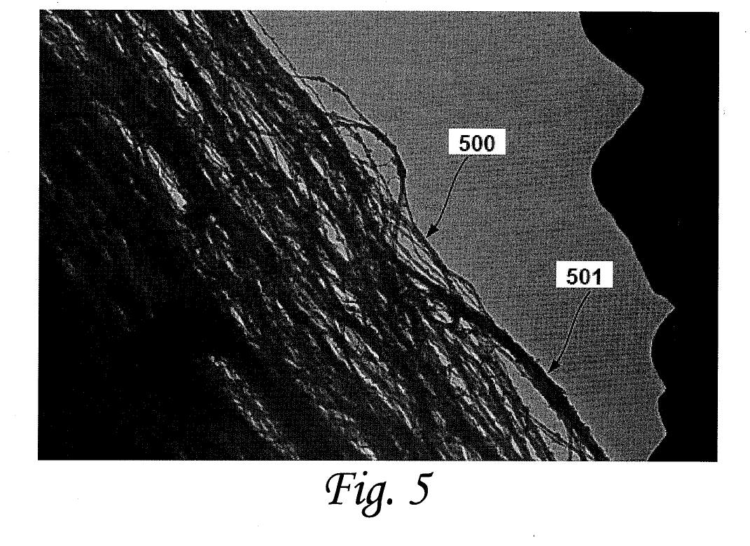

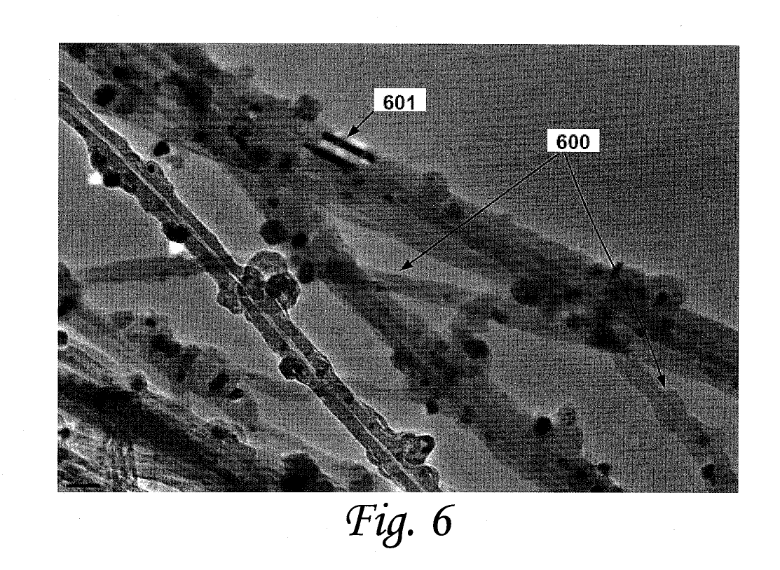

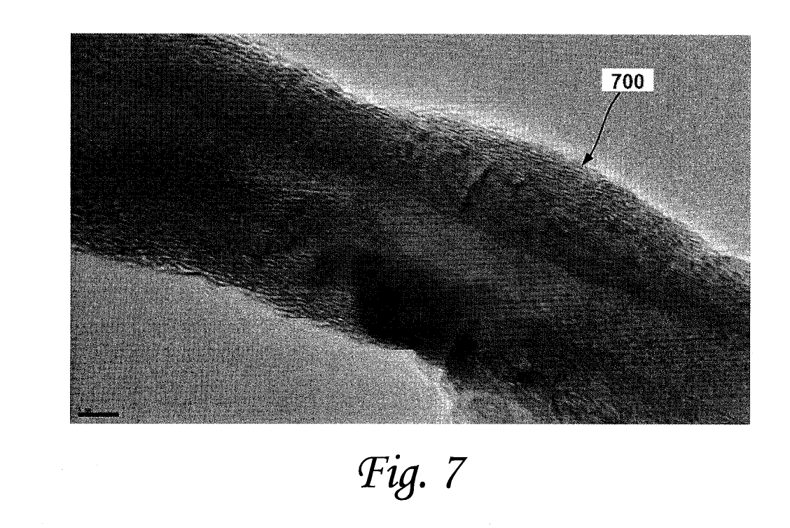

Refer to FIGS. 4-7. The SATS structures were further characterized using TEM with 25 progressively increased magnification. FIG. 4 shows an overall view of a single SATS 400. The multi-wall CNTs are generally well aligned although not all perfectly parallel. The denser center region could be a result of a greater cross section. FIG. 5 shows detail of both alignment of the CNTs 500 and the presence of iron particle debris 501 inherent from the growth method. FIG. 6 shows individual multi-wall CNTs 600, providing a sense of their relative orientation, and also shows residual catalytic iron particles 601. FIG. 7 shows the multi-wall nature of these CNTs 700.

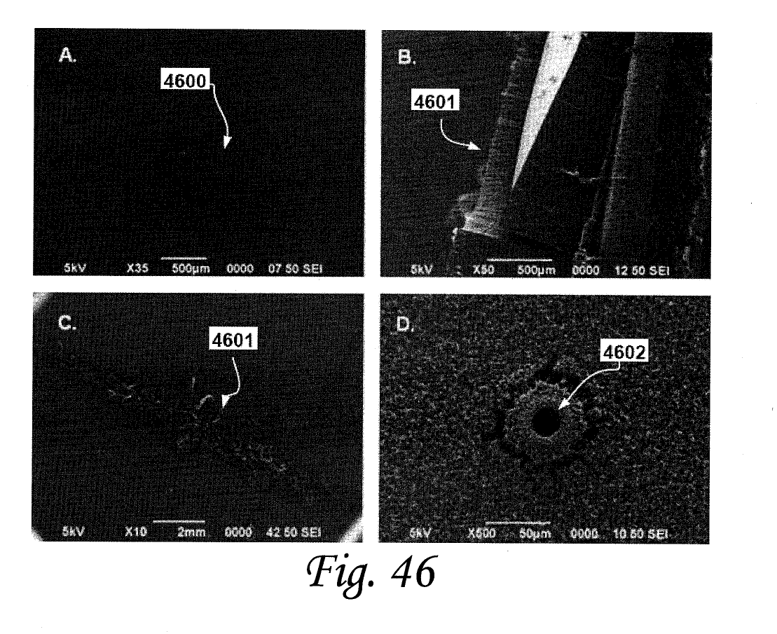

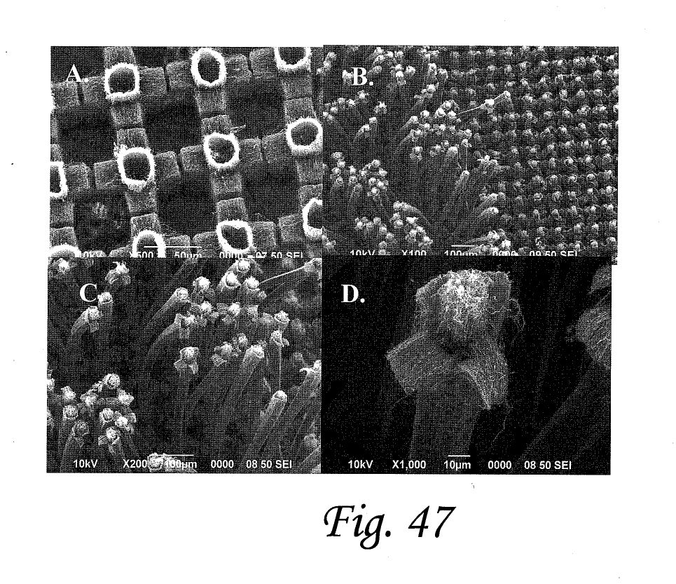

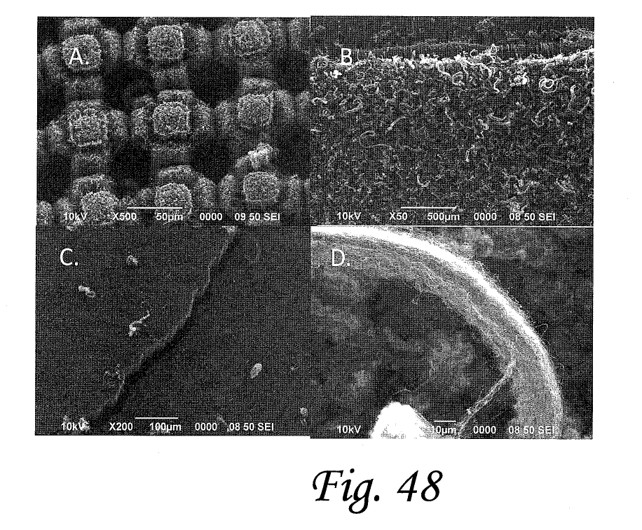

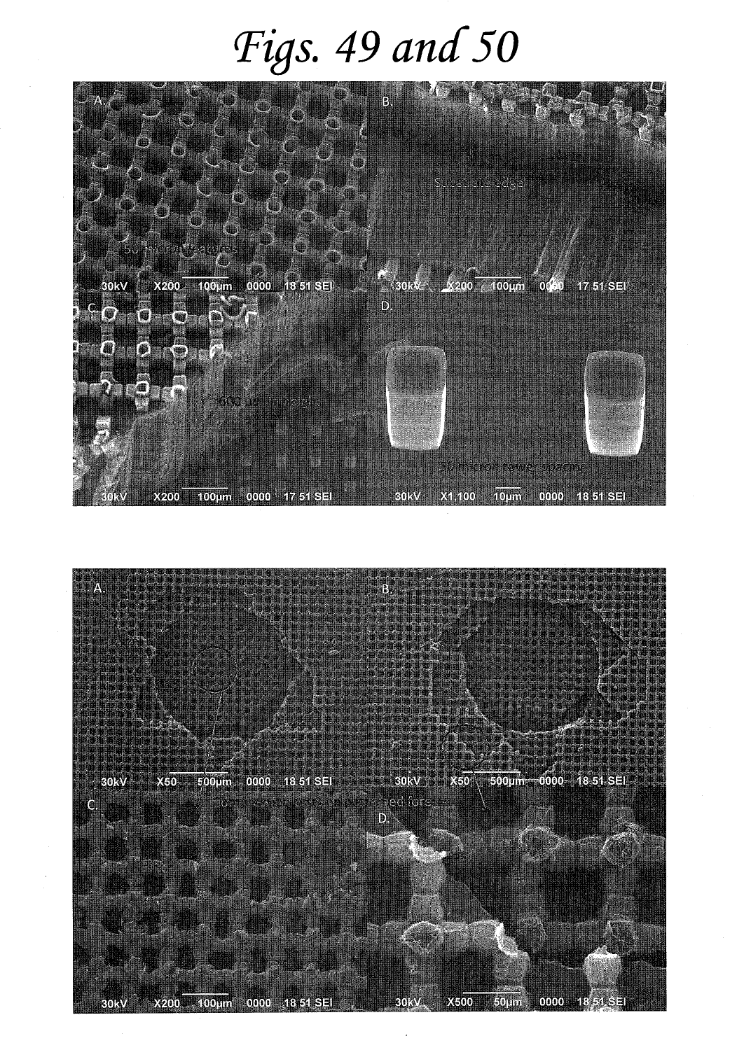

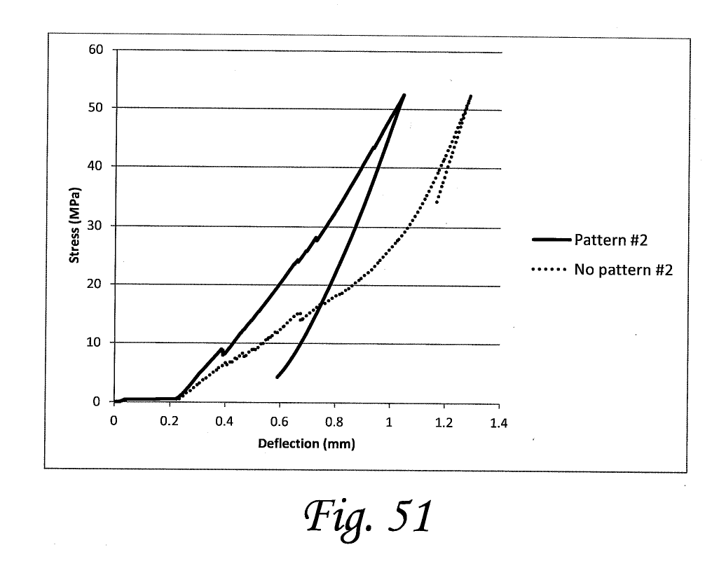

FIG. 46A shows the surface as prepared with the scratch 4600 inscribed. There were no irregularities other than the scratch 4600. After growth, a normal CNT forest 4601 is observed (FIGS. 46B and C). This result is contrary to results by other researchers who reported growth on single crystal silicon substrates is difficult without either depositing metal catalysts or xenon ion implantation. Chen et al. (2005), Yu et al. (2006), Yue et al. (2006). In addition, many SATS structures 4601 are entirely confined to the region of the scribed line 4600 (FIG. 46C). This result further supports the finding that surface roughness is necessary and sufficient to produce SATS.

Refer to FIG. 46D showing one of a number of holes 4602 with a characteristic morphology in the CNT forest 4601. These holes 4602 are not spatially associated with the scribed region 4600 and have a uniform surface density of approximately 1.5 holes/mm2. The repeated morphology of these holes 4602 consists of a very regular inner circular hole of approximately 20 microns in diameter, surrounded by a less-regular circular region of denser CNT forest growth with a diameter of approximately 55 microns. The density of this annular region has a radial dependency, appearing to be highest near the center and decreasing outward. There is also a distinct encircling outer narrow ring feature of approximately 75 microns in diameter that is characterized by an absence of CNTs.

These features may represent failed SATS growth sites, or conversely, locations where SATS were formed and then subsequently detached. The nearly atomically smooth substrate 100 may imply formation followed consistently by release. Thus, the dynamic forces felt at the base during growth likely exceed the bond or adhesion strength. This suggests initiation and growth from the substrate 100 upward versus initiation from the forest surface and growing both downward and upward simultaneously. An alternate explanation may be a mechanism that consistently shears off a proto-SATS at the forest surface. Such a mechanism could be associated with gaseous reactant release from the encircling annular break (hole) 4602 in the CNT forest 4600. Common to all cases, effects from the flow of gaseous reactants within and through the CNT forest 4600 need be considered. The interaction among inhomogeneities, irregularities, and surface roughness is almost 25 certain to change the gaseous reactant flow properties and hence the localized reaction conditions.

For the above specific growth conditions, formation of the SATS is associated with surface roughness or a locally “enhanced” surface area such as the inscribed scratch 4600. As shown in FIGS. 44B and C, the roughness is provided by the Si particles. Roughness in the form of a scribe-damaged surface 4600 (FIG. 46A) is also shown as a means to promote SATS growth. While iron is also present in the system, as derived from the ferrocene catalyst, it is only observed as very small particles 601 common to individual multi-wall CNTs (FIG. 6). Given that SATS are observed, in the instance of these experiments, only when Si particles are present, and are not observed in the control sample, any direct contribution of iron to the surface roughness effect is negligible. However, iron may have a collaborative and contributory role when used with silicon particles.

The intentional production of surface roughness being both necessary and sufficient to form SATS for these specific catalytic CVD growth conditions is established. With either the inscribed irregularities or deposited silicon particles, heterogeneous nucleation sites are formed, i.e., these “irregularities” decrease the free energy needed for formation of the SATS. This preferentially promotes formation of a hierarchal tube structure. While initiation of growth at the substrate surface is highly likely, interactions and effects from the forest top surface may be possible. A contributing factor may include the evolving conditions of gaseous reactant flow, both above and especially below the forest surface during the growth process. Musso, S. et al., Fluid Dynamic Analysis of Gas Flow in a Thermal-CVD System Designed for Growth of Carbon Nanotubes, J Cryst Growth, 310(2):477-83; 2008.

For tensile testing, each SATS was laid on a tab of standard cardstock across a central horizontal disposed rectangular cut-out, producing a gage length of approximately 500 microns. While spanning the cut-out, both ends of the SATS were attached to the cardstock using Loctite Fixmaster Epoxy Pak (as detailed in ASTM D3379-75, withdrawn 1998). Specimens were then loaded into the tensile apparatus (not shown separately), which consisted of a lever arm, a counterweight, and a Sartorius Type 1602 MP 8-1 balance. The upper and lower tabs were gripped by Pelco reverse tweezers at both the lever arm end and fixed counterweight points. The two sides of the card stock were then cut with the balance zeroed. The lever arm was then pushed downward a fixed distance past the fulcrum using a calibrated micrometer screw gauge to provide a known displacement. On the opposite side, this lifted the attached counterweight off the balance under the support of the SATS only. 25

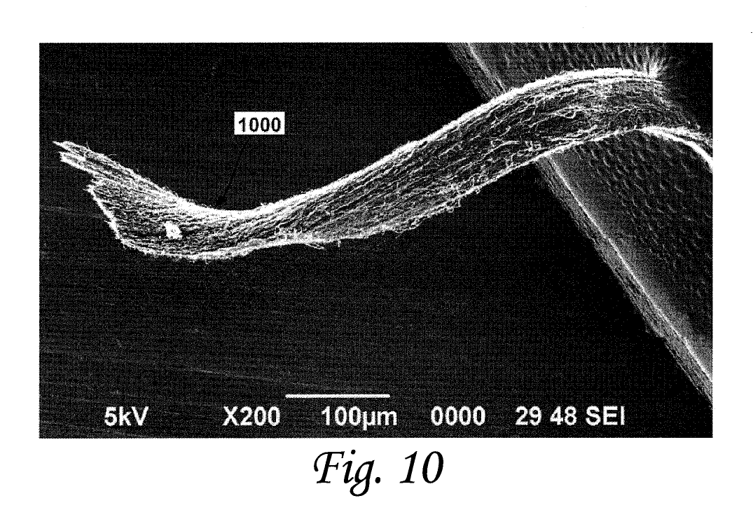

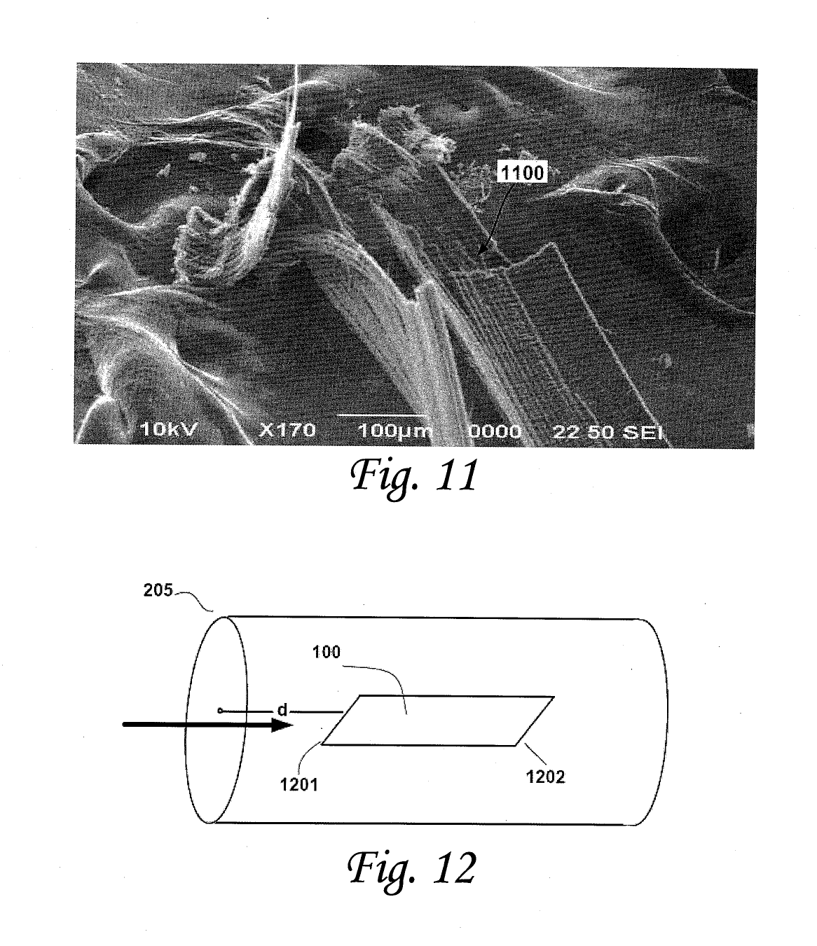

In addition, the SATS were characterized by measurement of their ultimate tensile strength (UTS). A preliminary value of 140 MPa was obtained. Without optimization, this is approximately 32% of the UTS for a common commercial steel (i.e., AISI 1018). FIG. 10 is an example of the tensile failure surface 1000 on the left side. In this case there is no evidence of permanent deformation, suggesting a brittle failure mechanism. A different SATS sample that failed during preparation also suggests brittle failure. FIG. 11 shows the result of some uncharacterized lateral loading. Here a number of longitudinal fractures 1100 are evident, suggesting the presence of only weak cross bonding perpendicular to the long axis.

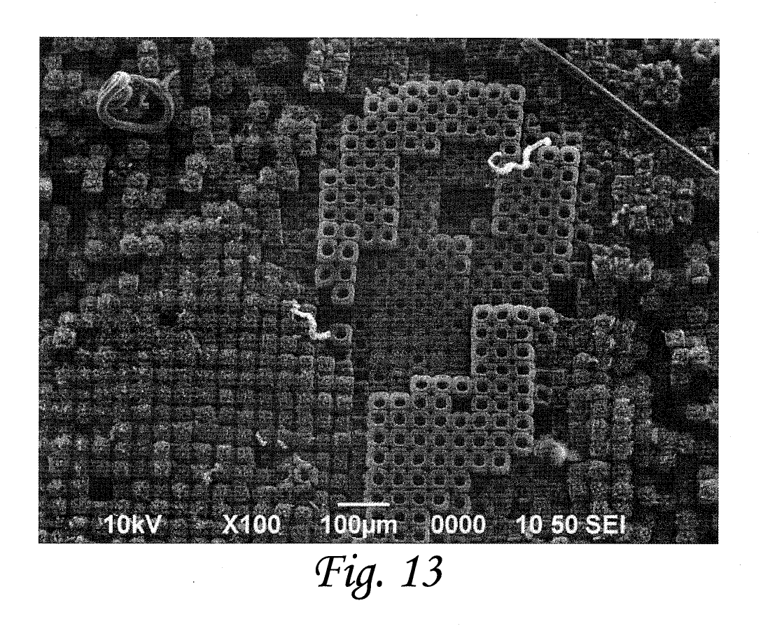

Further investigation involved using more control to prepare the surface of the substrate 100. Standard photo-resist and processing techniques from the semi-conductor industry used Deep Reactive Ion Etching (DRIE) to produce a very regular array of square 25×25 micron towers, 75 microns high. Column spacing for four different configurations of 12.5, 25, 37, and 50 microns were designed, examples of all these configurations are described below and represented in the Figures. Refer to FIGS. 13-18 and 20-22 for examples of the towers.

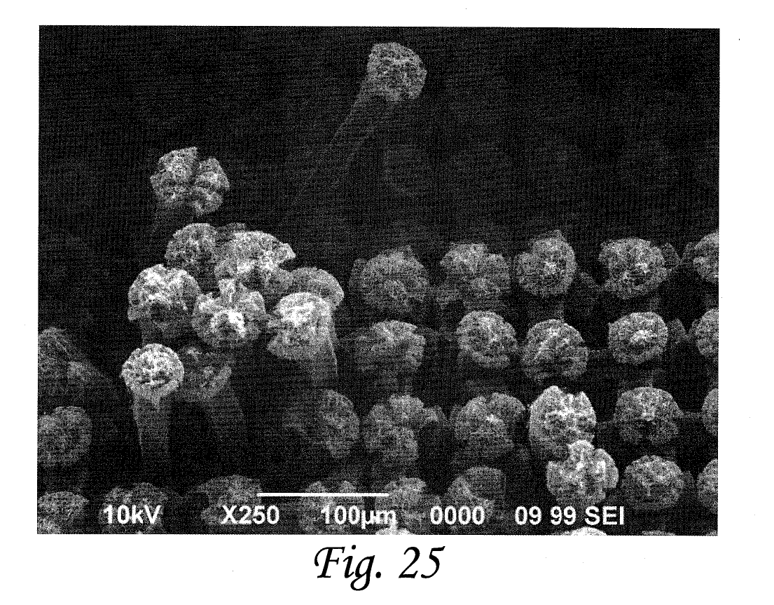

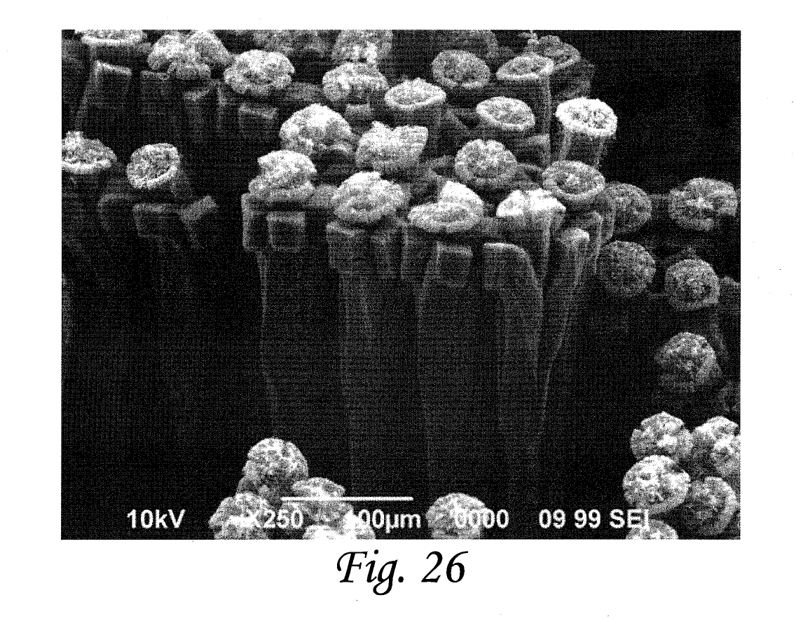

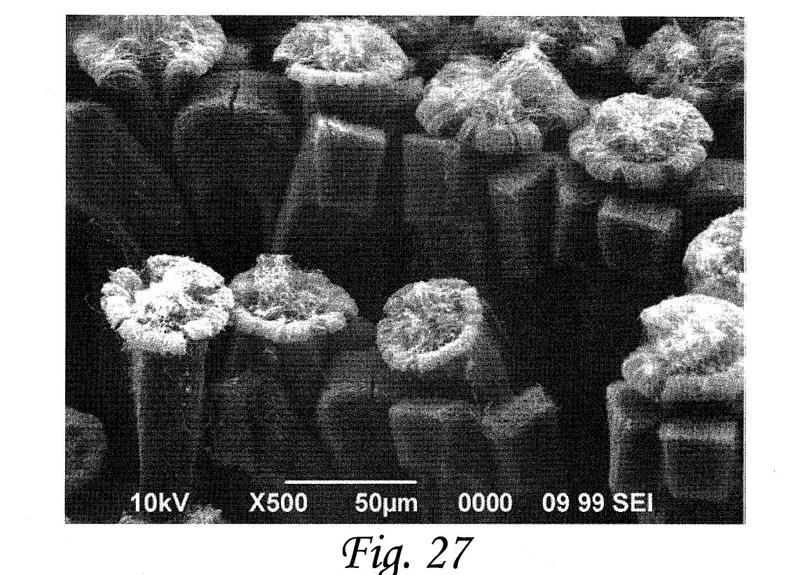

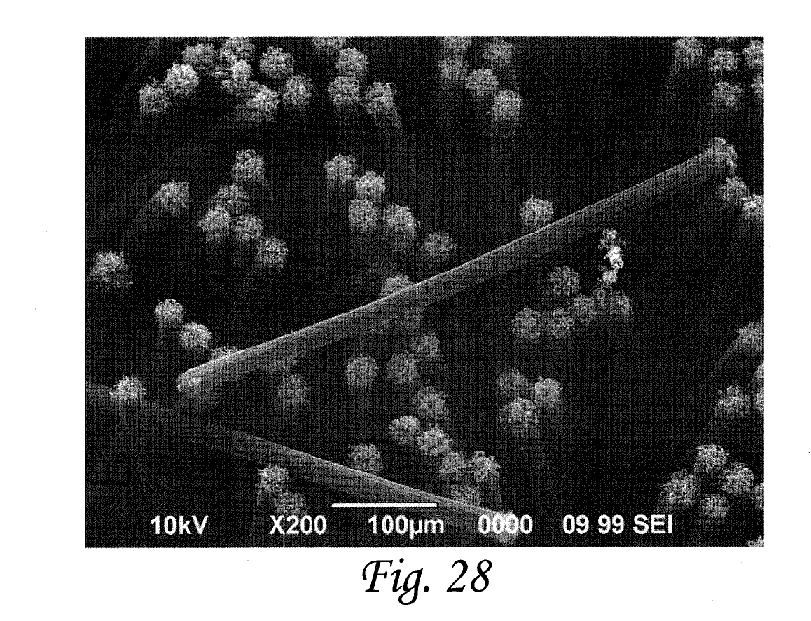

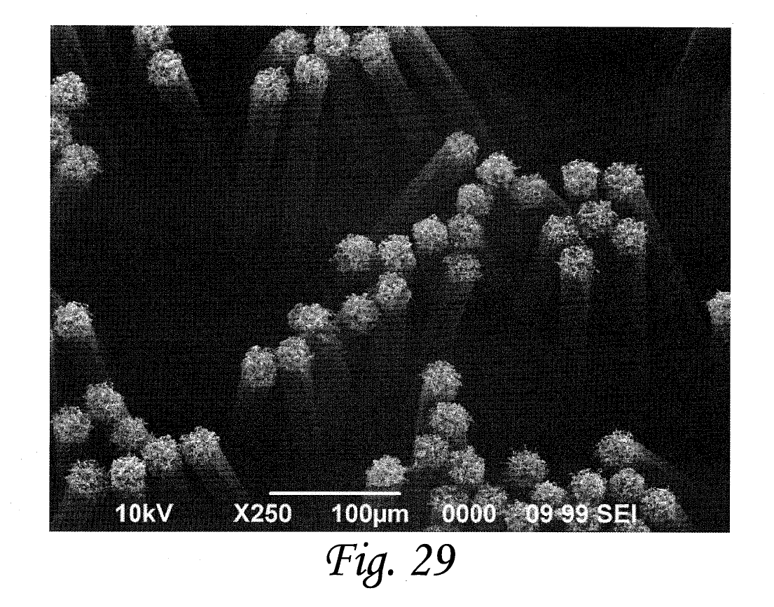

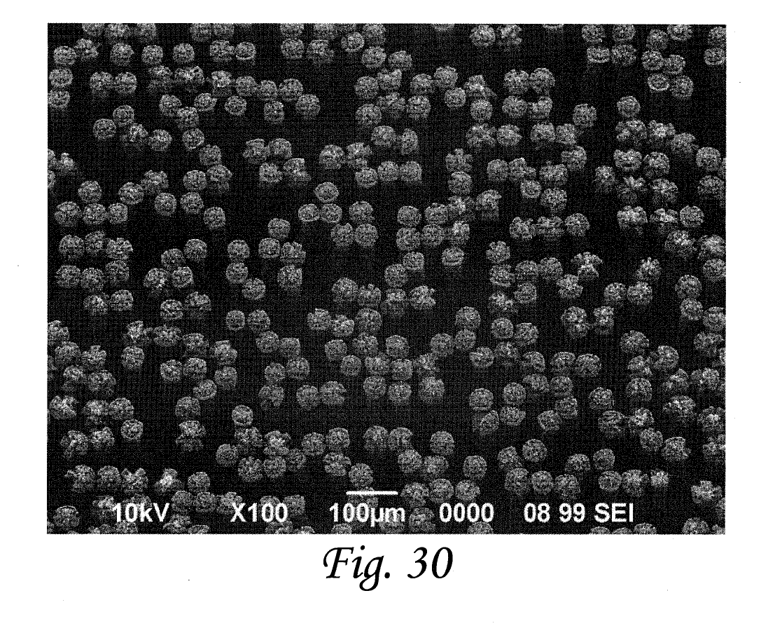

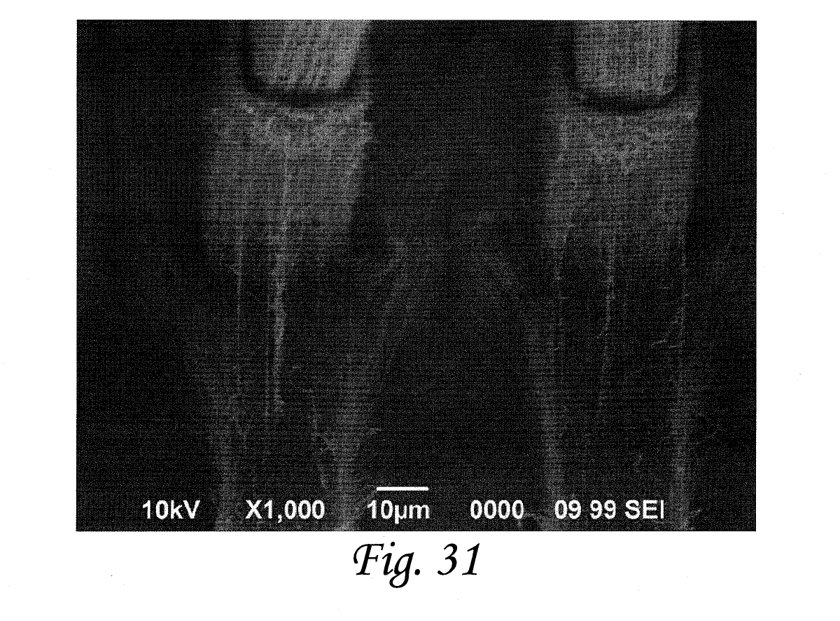

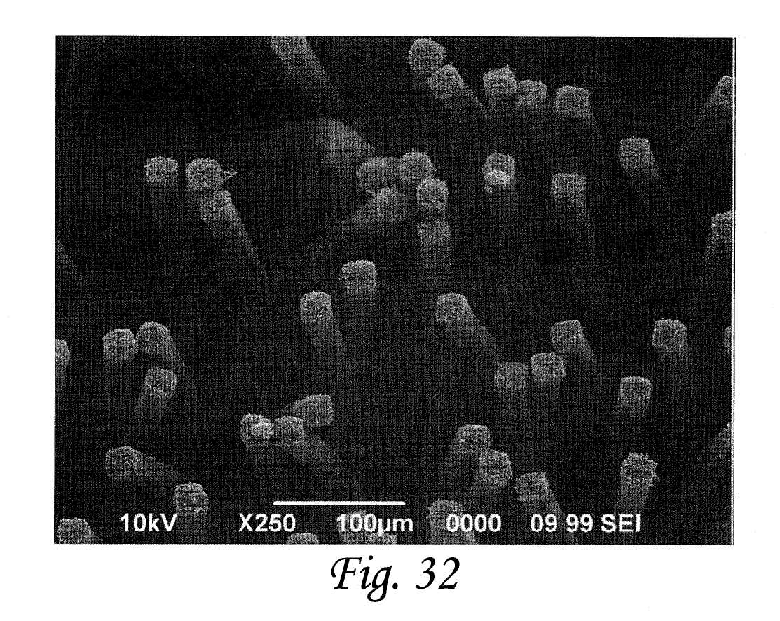

A first array was grown using a position in the reactor tube 205 that placed the leading edge of the prepared substrate 22 cm from the entrance of a 20 mL xylene/ferrocene flow at a rate of 0.75 L/min to the reactor tube 205 with a 37.5 micron column spacing and 25 micron column width. FIGS. 25-32 show results of the tower growth. FIG. 25 shows the tops of the towers at the leading edge enlarged at 250×. FIG. 26 is an elevation view of the tops of the towers showing the formation of cubes on each side of the tops of the towers enlarged at 250×. FIG. 27 is an elevation view of the tops of the towers showing the formation of cubes on each side of the tops of the towers enlarged at 500×. FIG. 28 shows the tops of the towers at the midpoint enlarged at 200×. FIG. 29 shows the tops of the towers at the midpoint enlarged at 250×. FIG. 30 shows the tops of the towers at the midpoint enlarged at 100×. FIG. 31 shows a close-up of the tops of the towers at the trailing edge enlarged at 1000×. FIG. 32 shows the tops of the towers at the trailing edge enlarged at 250×.

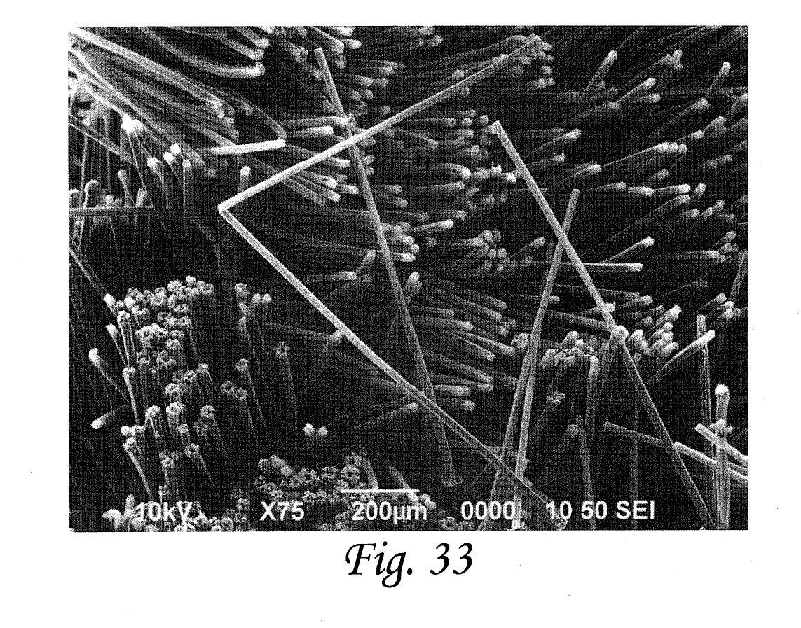

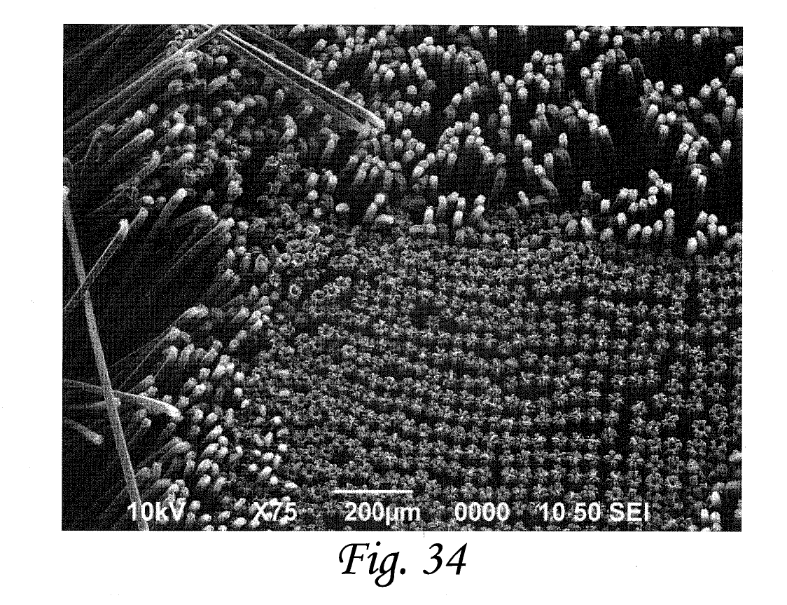

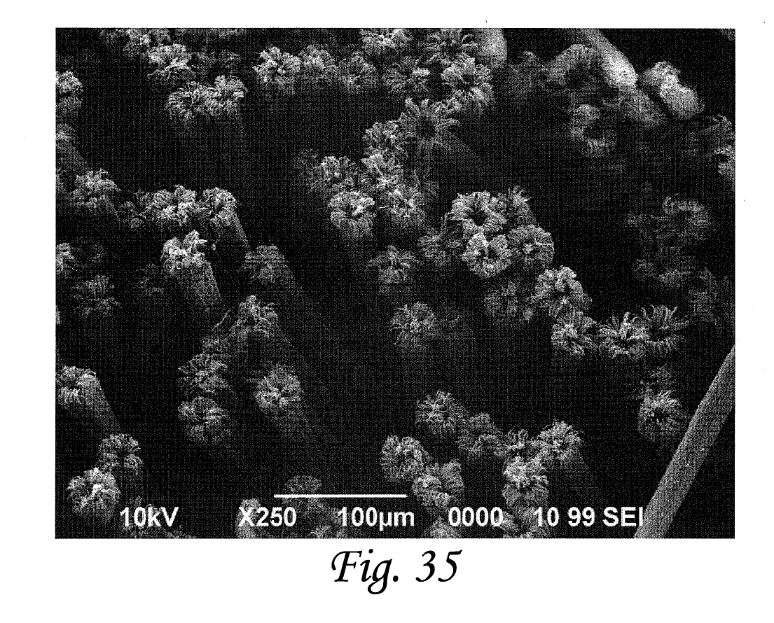

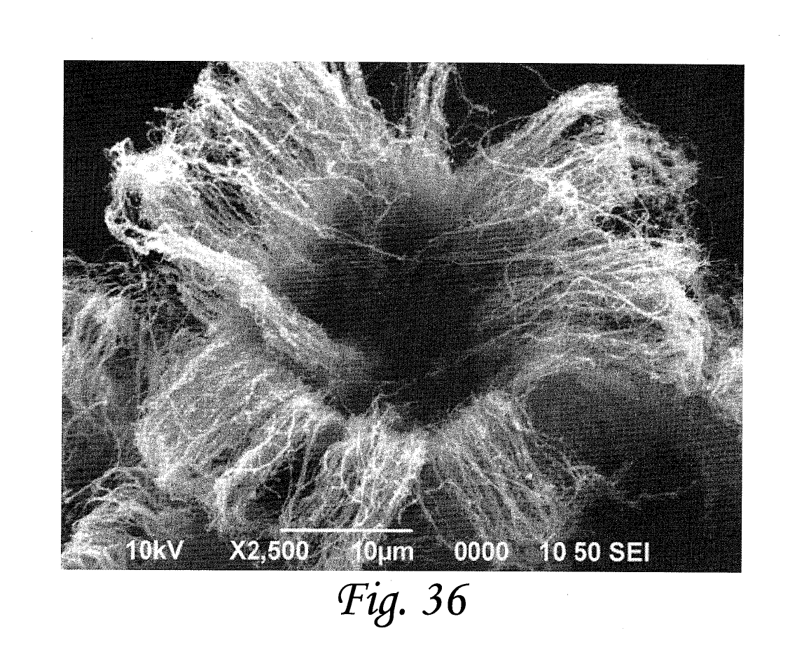

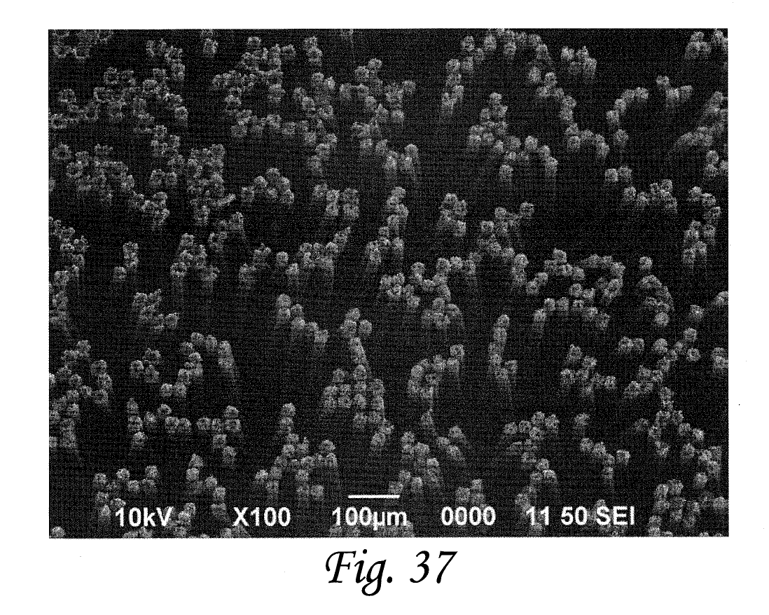

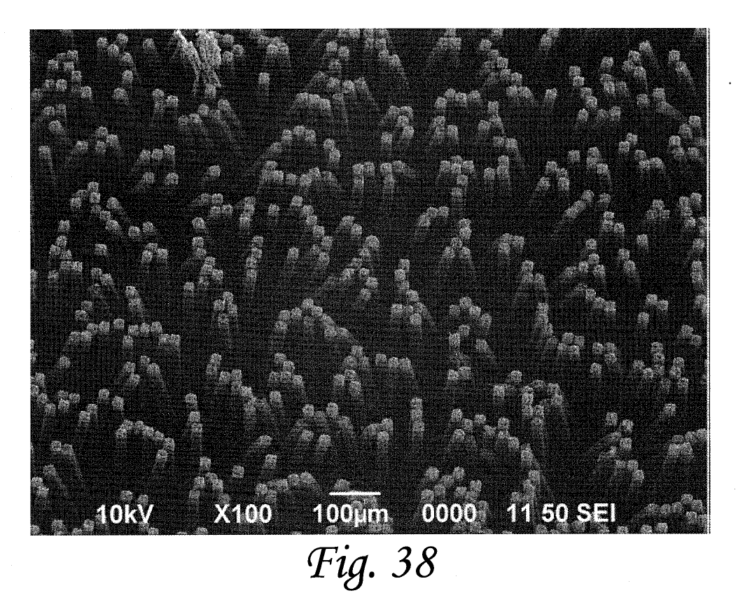

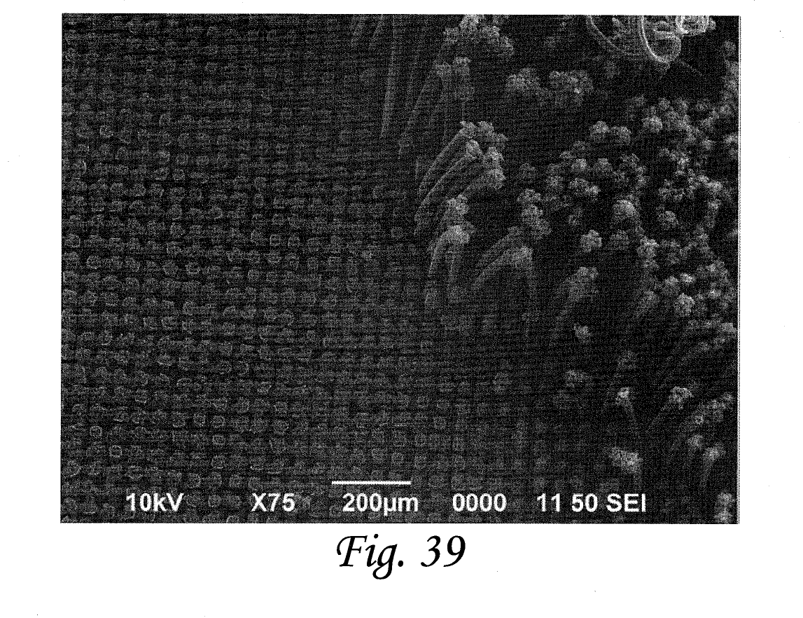

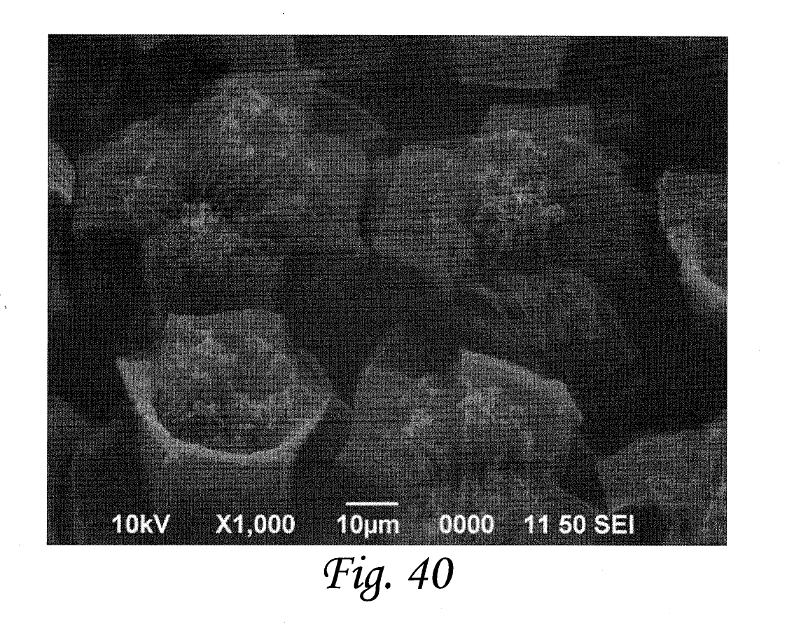

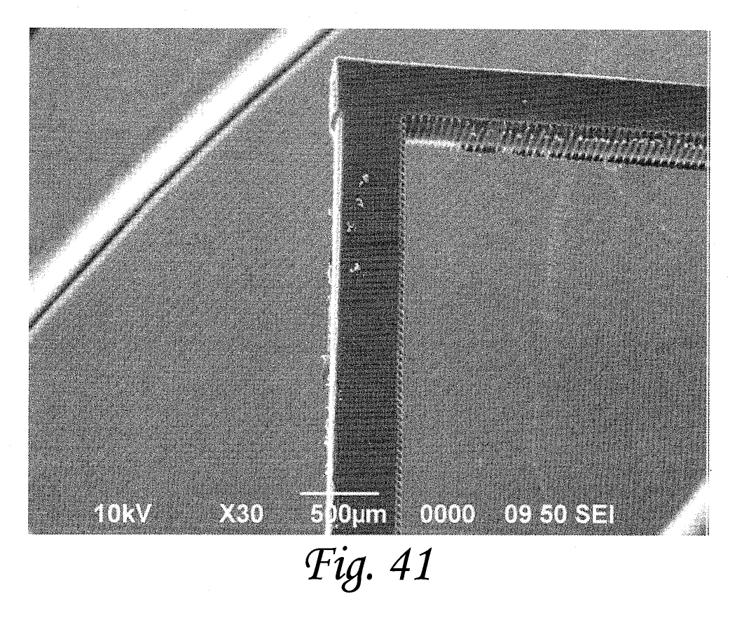

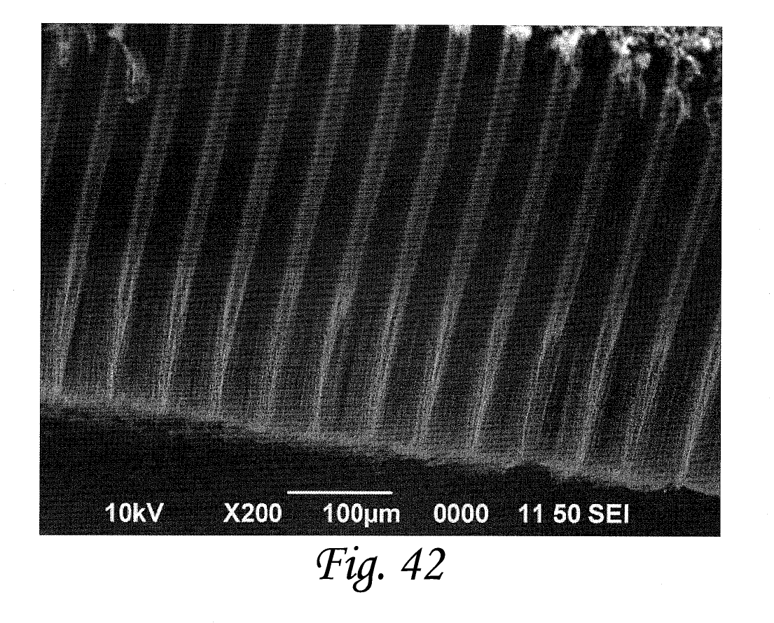

A second array was grown using a position in the reactor tube 205 that placed the leading edge of the prepared substrate 20 cm from the entrance of a 25 mL xylene/ferrocene flow at a rate of 0.75 L/min to the reactor tube 205 with a 25 micron column spacing and 25 micron column width. FIGS. 33-46 show results of the tower growth. FIG. 33 shows the tops of the towers with some dislodged towers at the leading edge enlarged at 75×. FIG. 34 shows the tops of the towers at the leading edge enlarged at 75× with some partially grown towers. FIG. 35 shows the tops of the 25 towers enlarged at 250×. FIG. 36 shows a close-up of the top of a tower at the leading enlarged at 2500×. FIG. 37 shows the tops of the towers at the midpoint enlarged at 100×. FIG. 38 shows the tops of the towers at the trailing edge enlarged at 100×. FIG. 39 shows a perspective view of the towers at the trailing edge enlarged at 75×. FIG. 40 shows the tops of the towers at the trailing edge enlarged at 1000×. FIG. 41 shows the surrounding rim of a dense, long CNT forest that held together even as the underlying substrate 100 cracked off while being removed from the quartz tube 205. FIG. 42 shows the surrounding CNT forest rim, with CNT length of approximately 1170 microns, on the leading edge enlarged at 200×.

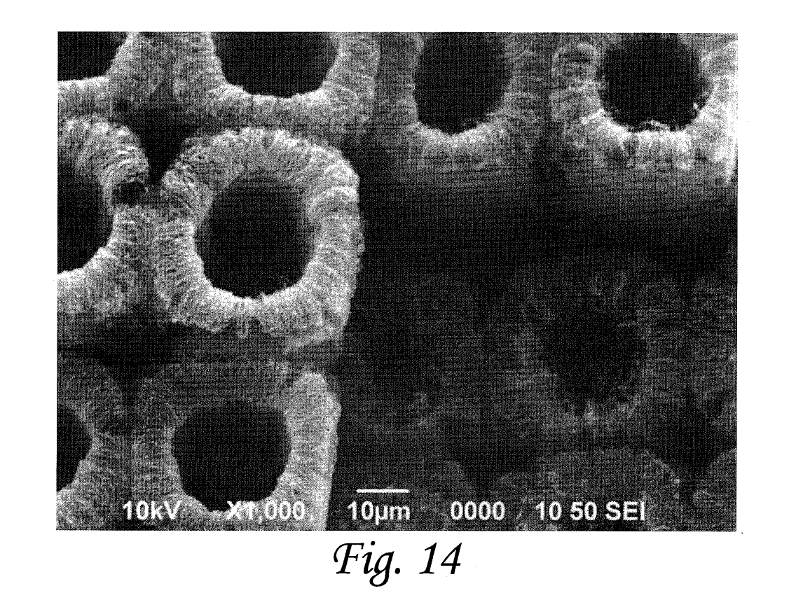

A third array was grown using a position in the reactor tube 205 that placed the leading edge of the prepared substrate 20 cm from the entrance of a 20 mL xylene/ferrocene flow at a rate of 0.75 L/min to the reactor tube 205 with a 12.5 micron column spacing and 25 micron column width. FIGS. 13-24 show results of the tower growth. FIG. 13 shows the tops of the towers at the leading edge enlarged at 100×. FIG. 14 is close-up of the tops of the towers at the leading edge enlarged at 100×.

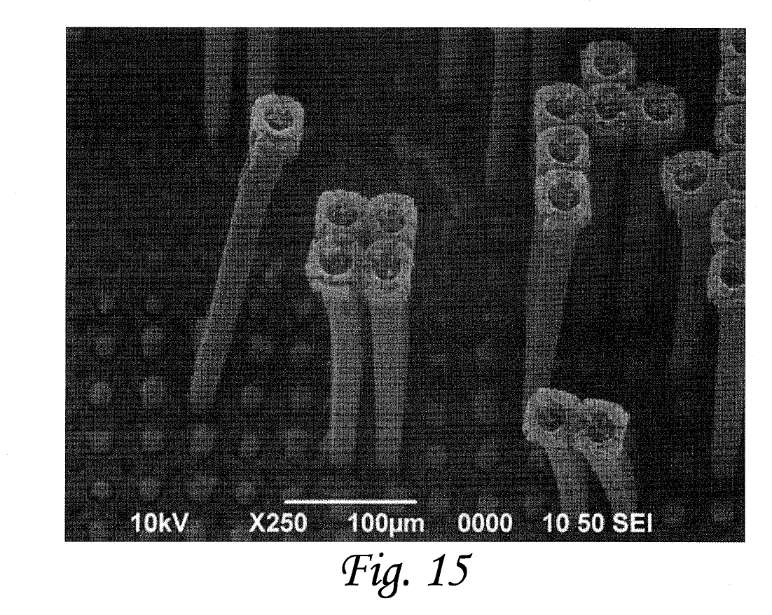

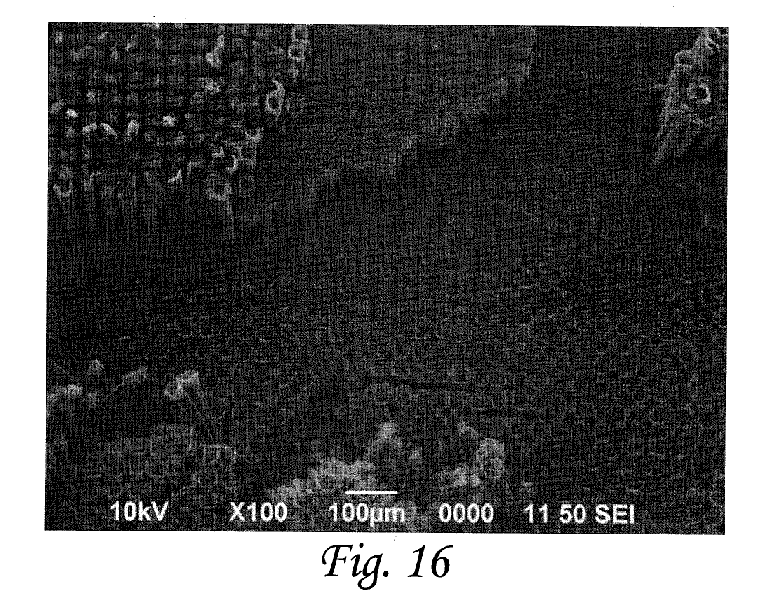

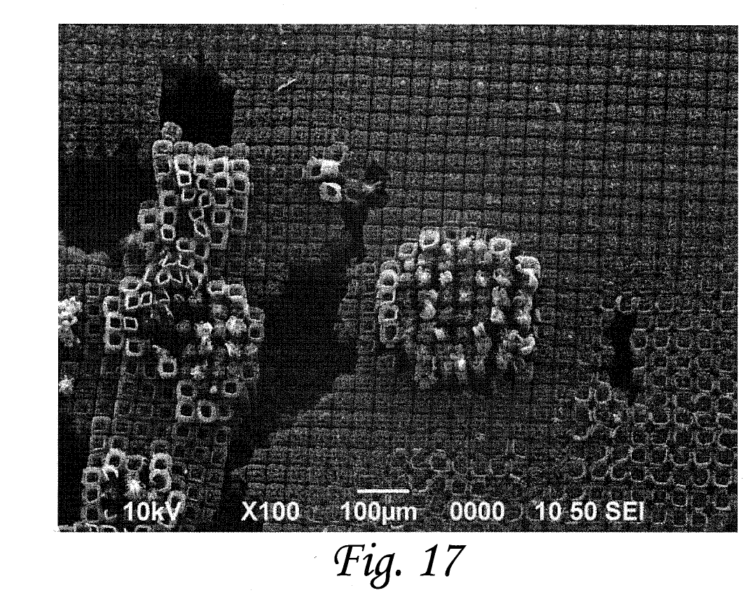

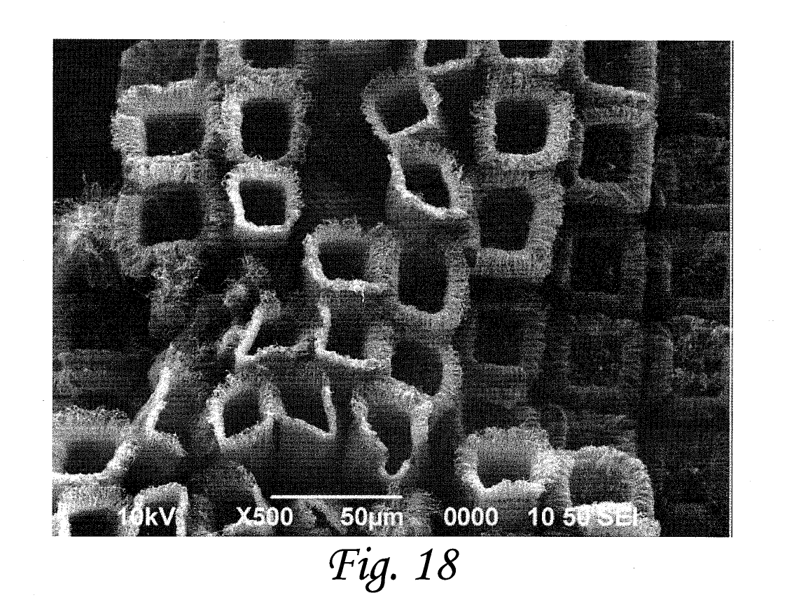

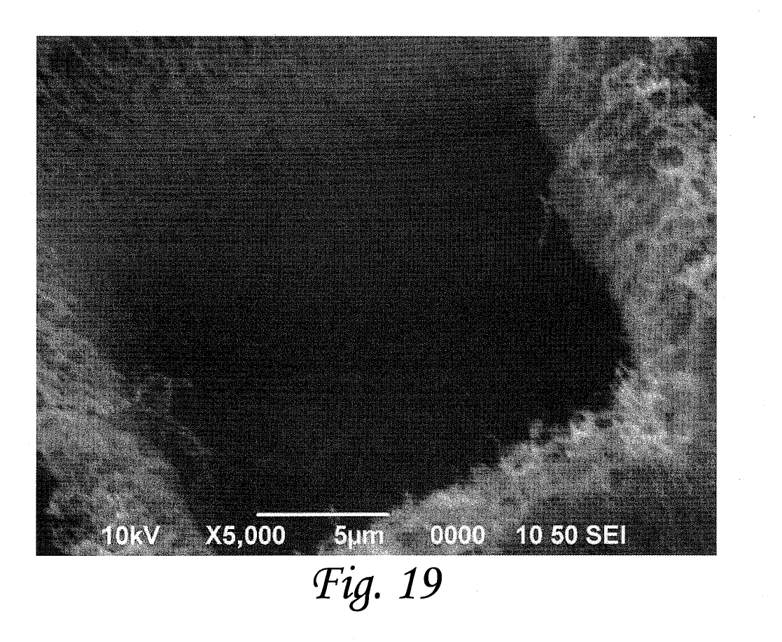

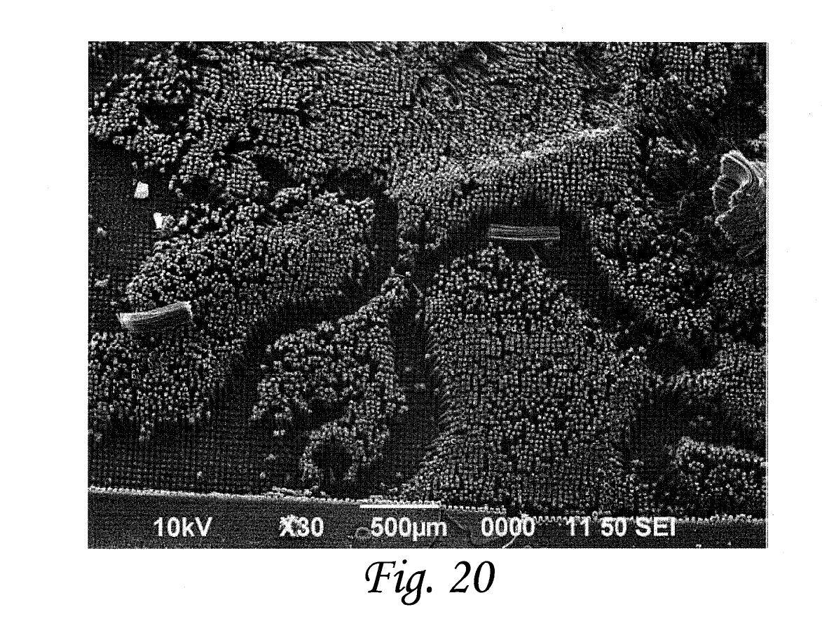

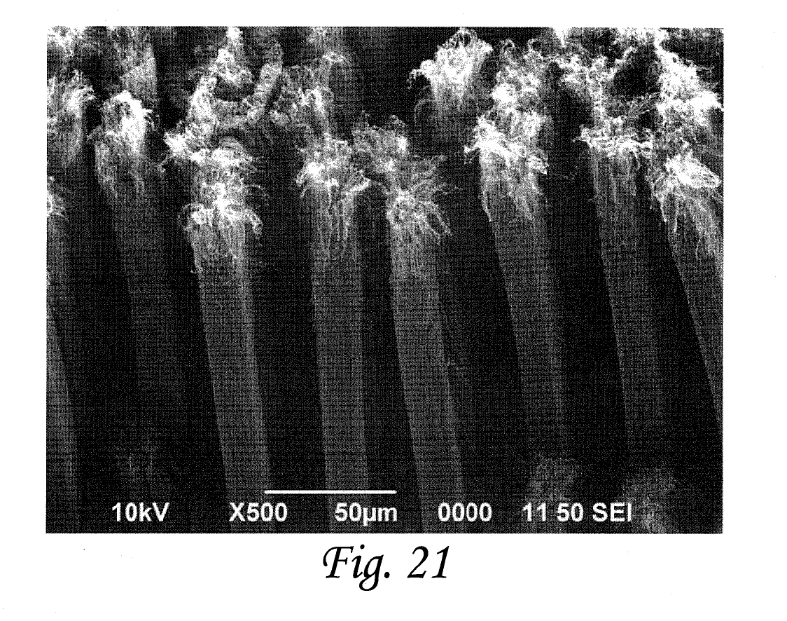

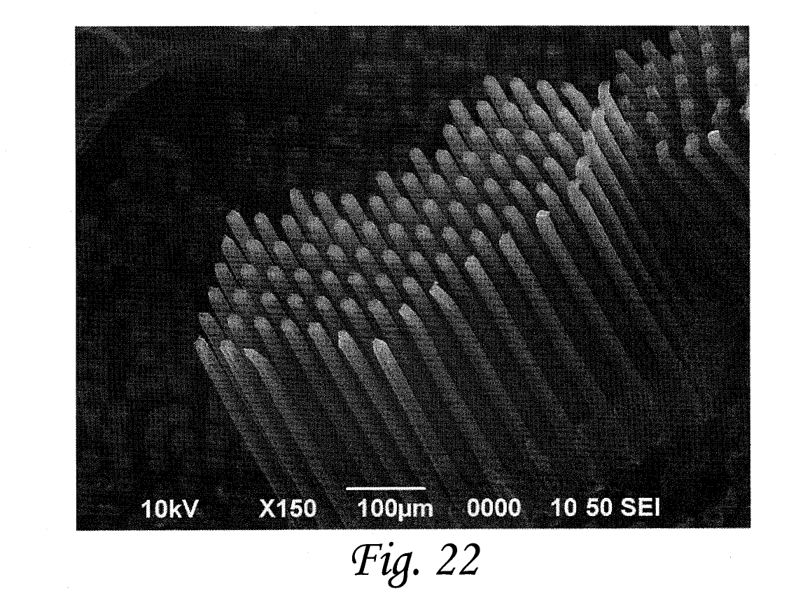

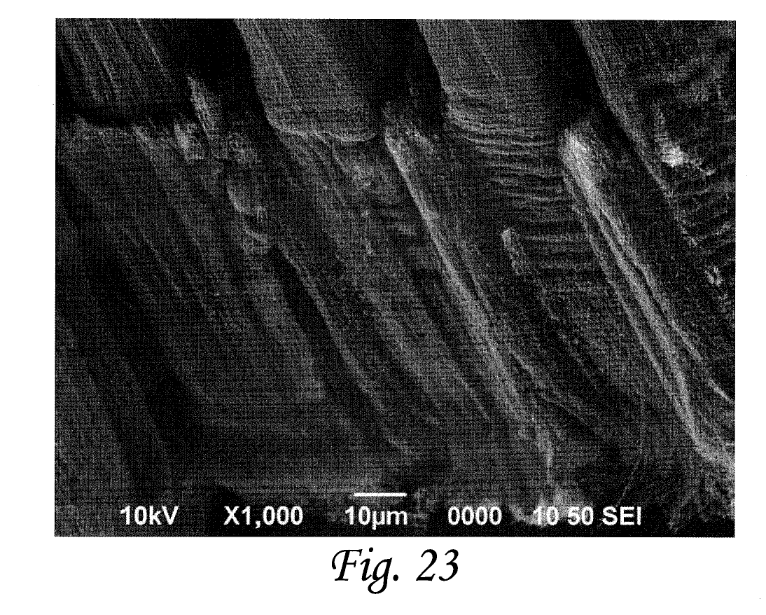

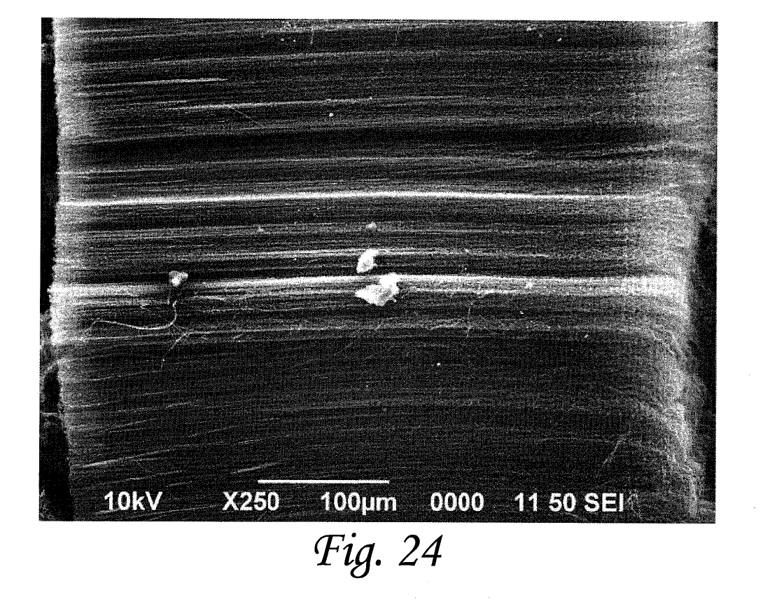

FIG. 15 is a perspective view of the towers enlarged at 250×. FIG. 16 shows a perspective view of the towers at the midpoint enlarged at 100×. FIG. 17 shows the tops of the towers at the midpoint enlarged at 100×. FIG. 18 shows the tops of the towers at the midpoint enlarged at 500×. FIG. 19 shows a close-up of the tops of the towers at the midpoint enlarged at 5000×. FIG. 20 is a perspective view of the towers at the trailing edge enlarged at 30×. FIG. 21 is an elevation view of the towers at the trailing edge enlarged at 500×. FIG. 22 is a perspective view of a broken off piece of towers at the trailing edge enlarged at 150×. FIG. 23 is a close-up of a broken off piece of towers at the trailing edge enlarged at 1000×. FIG. 24 shows pieces of iron among the towers at the trailing edge enlarged at 250×.

A fourth array was grown using a position in the reactor tube 205 that placed the leading edge of the prepared substrate 20 cm from the entrance of a 25 mL xylene/ferrocene flow at a rate of 0.75 L/min to the reactor tube 205 with a 50 micron column spacing and 25 micron column width. FIGS. 47A, 47B, 47C & 47D show results of the tower growth, and are all views from the top side of the substrate. FIG. 47A shows the claimed QUAD configuration and is from the leading edge, 47B, 47C & 47D are from the middle. FIG. 48A shows the trailing edge of the top of the substrate and resembles the QUAD configuration, albeit with “softened” edges. FIGS. 48B, 48C & 48D show results from the bottom of the substrate.

FIG. 49A shows yet another view of the QUAD configuration, FIGS. 49B and 49C show instances where non-SATS material grows on the substrate between the substrate and the SATS material and FIG. 49D is an excellent perspective of two towers with 50 micron spacing.

FIG. 50A shows the QUAD configuration after compression testing and FIG. 50C shows an enlarged view of a central section of the tested section. FIG. 50D shows the diagonal propagation of the fracture outside the testing area of a portion of FIG. 50B above it.

FIG. 51 shows the plot of the claimed compression testing results, the solid line to the left being in accordance with the claimed invention and the dotted line to the right being a control.

Note the “splitting” behavior after some amount of SATS growth. At the 37.5 micron spacing (see FIG. 27) above this takes the form of reproducing the square base geometry in each of the four faces. Assuming any kind of surface reaction (gas or liquid) this could yield considerable specific area.

Other possibilities for preparing a substrate include surface rows with a power law or log normal type of increasing spacing, or a variation employing concentric circles. A wide variety of patterns or features could be prepared and then CNTs grown on them. One purpose would be to grow patterns, such as fractal patterns, to have a set of discrete responses for producing radio wave passive sensors. Upon external perturbation or some other sensing reaction, the patterned CNT 25 forest is disturbed and the EM signature altered, permitting remote detection.

There are many potential uses for and applications of the SATS structure. Directed growth of interconnects for integrated circuits may be possible. Through control of chirality the conductive properties could be further designed for purpose. Given appropriate substrate material, SATS may be employed in electronic connections or sequential semiconductor junctions. Applications could include “super” capacitors, strain sensing, piezoelectric coated generation including a variation with dielectric elastomers, and conductive IC-chip interconnects and the like. Further, SATS may be incorporated in hybrid structures that employ both electrical conduction and controlled micro-fluidics to mimic nervous system activity. Possibilities include use as a boundary layer surface treatment to affect fluid flow and heat transfer. Medical applications include scaffolding for blood vessel or nerve cells, kidney structures, cochlear implants to restore hearing, and the like.

### POSSIBLE EMBODIMENTS

### SATS

SATS-1. A Self-Assembled Tube Structure grown on a substrate under specified process conditions comprising an elongate body comprising a plurality of carbon nanotubes, said elongate body having a longitudinal axis and a proximal end and a distal end opposite said proximal end, said proximal end attached to said substrate either directly or indirectly (indirectly=attached to the substrate by non SATS material), said SATS being either hollow (having a central cavity) or solid, said SATS being generally symmetrical around said longitudinal axis.
SATS-2. The SATS of SATS-1, when viewed in an axial cross-section, i.e., a section taken perpendicular to and at a midpoint along said longitudinal axis, may be in the shape of a circle, an oval, a square, a rectangle, a triangle, a polygon, a sheet, or other geometric forms.
SATS-3. The SATS of any of SATS-1 to SATS-2, when viewed in an axial cross-section at said distal end, i.e., a section taken perpendicular to said longitudinal axis, may expand into a cross section larger in area than said midpoint axial cross section.
SATS-4. The SATS of any of SATS-1 to SATS-3 wherein a shape of said expanded distal end is selected from the group consisting of a flared end, a flower like end, at least one petal-shaped element, at least one petal shaped end terminating in a square, frayed rope, and combinations thereof.
SATS-5. The SATS of SATS-1 wherein said midpoint axial cross-section is in the shape of a cross.
SATS-6. The cross-shaped SATS of SATS-5 comprised of five sections, a central core, and four appendage sections in contact with said central core, said five sections being substantially similar in shape and area and in the form of squares, said four appendage sections each being positioned at 0 degrees, 90 degrees, 180 degrees and 270 degrees, respectively.
SATS-7. The cross-shaped SATS of SATS-5 comprised of at least four sections (“n”), one of said sections being a central core, and the remaining appendage sections (“n−1”) in contact with said central core, said remaining (“n−1”) sections being substantially similar in shape and area, and being positioned at positions in contact with said core, and equidistant from each other by an angular amount determined by the formula (360 degrees/(n−1))=angular amount.
SATS-8. The cross-shaped SATS of any of SATS-5 to SATS-7 wherein the central section of said cross is hollow.
SATS-9. The cross-shaped SATS of any of SATS-5 to SATS-7 wherein the central section of said cross is solid.
SATS-10. The SATS of SATS-1 having a cavity therein in the shape of the SATS.
SATS-10. The SATS of SATS-1 having a cavity therein in a different shape than the SATS.
SATS-11. The SATS of SATS-1 having a cavity with a cross-sectional area comprising 50% to 90% of the cross-sectional area of the SATS.
SATS-12. The SATS of SATS-1 having a cavity with a cross-sectional area comprising 10% to 50% of the cross-sectional area of the SATS.
SATS-13. The SATS of SATS-1 with a cross-sectional area, the longest linear dimension of which taken in any direction being less than about 25 microns.
SATS-14. The SATS of SATS-1 with a cross-sectional area, the longest linear dimension of which taken in any direction being less than about 50 microns.
SATS-15. The SATS of SATS-1 with a cross-sectional area, the longest linear dimension of which taken in any direction being less than about 100 microns.
SATS-16. The SATS of SATS-1 having an ultimate tensile strength of 20,000 psi.

SATS-17. The SATS of SATS-1 having a distance from proximal end to distal end of at least 3 millimeters.

### ARRAY

ARRAY-1. An array of at least 4 SATS of any of the preceding (SATS) claims in a 2×2 configuration. ARRAY-2. The array of ARRAY-1 wherein the SATS are in contact with each other. ARRAY-3. The array of ARRAY-1 wherein the SATS are circular in cross section and are separated from each other in every direction by a distance at equal to or greater than their diameter.
ARRAY-3. The array of ARRAY-1 wherein the SATS are square in cross section and are separated from each other in every direction by a distance at equal to or greater than their edge dimension.
THE QUAD ARRAY. An array of at least 4 cross-shaped SATS in a 2×2 configuration, each of said at least 4 cross-shaped SATS comprised of five sections, a central core, and four appendage sections in contact with said central core, said five sections being substantially similar in shape and area and in the form of squares, said four appendage sections each being positioned at 0 degrees, 90 degrees, 180 degrees and 270 degrees, respectively, and wherein an axis taken through the center of the 0 degree and 180 degree appendage of one of said SATS is aligned with an axis taken through the center of the 0 degree and 180 degree appendage of an adjacent SATS, and said 0 degree appendage is in contact with said 180 degree appendage of said adjacent cross-shaped SATS, and wherein an axis taken through the center of the 90 degree and 270 degree appendage of one of said SATS is aligned with an axis taken through the center of the 90 degree and 270 degree appendage of an adjacent SATS, and said 90 degree appendage is in contact with said 270 degree appendage of said adjacent cross-shaped SATS, thus forming a square shaped cavity central to said array having an area four times the area of an appendage.
THE QUAD ARRAY 2. The QUAD ARRAY having a greater stress versus deflection compressive stiffness of at least 20%, relative to a non-SATS control array, beginning at about 20 MPa of stress and continuing to at least about 50 MPa.
THE QUAD ARRAY 3. The QUAD ARRAY having fracture behavior wherein the fracture appears at a 45 degree angle and spreads through said array in a diagonal direction and through diagonally oriented cross-shaped SATS and travels outside the area of applied force.

### Process

A method of producing a Self-Assembled Tube Structure (SATS), said SATS comprising an elongate body comprising a plurality of carbon nanotubes, said elongate body having a longitudinal axis and a proximal end and a distal end opposite said proximal end, said proximal end attached to said substrate either directly or indirectly (indirectly=attached to the substrate by non SATS material), said SATS being either hollow (having a central cavity) or solid, said SATS being generally symmetrical around said longitudinal axis, said method comprising the steps of:
providing a prepared substrate in a reaction zone
introducing a catalyst into said reaction zone, said catalyst functioning to build said SATS
providing a source of carbon into said reaction zone
providing an atmosphere of shield gas into said reaction zone to keep oxygen away from said reaction zone, and
providing heat to said reaction zone, wherein at least one SATS is produced.

The method of producing SATS wherein said prepared substrate is a silicon substrate with silicon particles distributed thereon.

The method of producing SATS wherein said prepared substrate is a silicon substrate having channels and towers and is prepared by deep reactive ion etching.

The method of producing SATS wherein said carbon source and said catalyst are combined and are selected from the group consisting of ferrocene and metallocene, and are in solution, said solution being introduced into said reaction zone by atomization.

The method of producing SATS wherein said atomization is performed by an ultrasonic device.

The method of producing SATS wherein said reaction zone is a tubular furnace.

The method of producing SATS wherein the temperature measured at the substrate is in the range of 800 degrees C. to 850 degrees C.

The method of producing SATS wherein the temperature measured at the substrate is about 820 degrees C.

The method of producing SATS wherein said shield atmosphere is selected from the group consisting of hydrogen, helium, argon and nitrogen.

The abstract of the disclosure is provided to comply with the rules requiring an abstract that will allow a searcher to quickly ascertain the subject matter of the technical disclosure of any patent issued from this disclosure. (37 CFR §1.72(b)). Any advantages and benefits described may not apply to all embodiments of the invention.

While the invention has been described in terms of some of its embodiments, those skilled in the art will recognize that the invention can be practiced with modifications within the spirit and scope of the appended claims. For example, although the system is described in specific examples for growing SATS, it may be used for producing any type of CNTs that may be useful in such diverse applications as electronics, medical devices and treatment, security systems, military systems and the like. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Thus, it is intended that all matter contained in the foregoing description or shown in the accompanying drawings shall be interpreted as illustrative rather than limiting, and the invention should be defined only in accordance with the following claims and their equivalents.

We claim:

1. A Self-Assembled Tube Structure (SATS) grown on a substrate under specified process conditions comprising an elongate body comprising a plurality of carbon nanotubes, said elongate body having a longitudinal axis and a proximal end and a distal end opposite said proximal end, said proximal end attached to said substrate either directly or indirectly by attachment to the substrate by non SATS material, said SATS being either hollow and having a central cavity or solid, said SATS being generally symmetrical around said longitudinal axis.

2. The SATS of claim 1, when viewed in an axial cross-section, i.e., a section taken perpendicular to and at a midpoint along said longitudinal axis, may be in the shape of a circle, an oval, a square, a rectangle, a triangle, a polygon, a sheet, or other geometric forms.

3. The SATS of any of claim 1, when viewed in an axial cross-section at said distal end, i.e., a section taken perpendicular to said longitudinal axis, may expand into a cross section larger in area than said midpoint axial cross section.

4. The SATS of claim 3 wherein a shape of said expanded distal end is selected from the group consisting of a flared end, a flower like end, at least one petal-shaped element, at least one petal shaped end terminating in a square, frayed rope, and combinations thereof.

5. The SATS of claim 2 wherein said midpoint axial cross-section is in the shape of a cross.

6. The cross-shaped SATS of claim 5 comprised of five sections, a central core, and four appendage sections in contact with said central core, said five sections being substantially similar in shape and area and in the form of squares, said four appendage sections each being positioned at 0 degrees, 90 degrees, 180 degrees and 270 degrees, respectively.

7. The cross-shaped SATS of claim 6 wherein the central section of said cross is hollow.

8. The cross-shaped SATS of claim 6 wherein the central section of said cross is solid.

9. The SATS claim 1 having an ultimate tensile strength of 20,000 psi.

10. The SATS of claim 1 having a distance from proximal end to distal end of at least 3 millimeters.

11. An array of at least 4 SATS of claim 1 in a 2×2 configuration.

12. An array of at least 1,000 SATS of claim 1 in a 100×100 configuration.

13. The array of claim 11 wherein the SATS are in contact with each other.

14. The array of claim 11 wherein the SATS are circular in cross section and are separated from each other in every direction by a distance at equal to or greater than their diameter.

15. An array of at least 4 cross-shaped SATS in a 2×2 configuration, each of said at least 4 cross-shaped SATS comprised of five sections, a central core, and four appendage sections in contact with said central core, said five sections being substantially similar in shape and area and in the form of squares, said four appendage sections each being positioned at 0 degrees, 90 degrees, 180 degrees and 270 degrees, respectively, and wherein an axis taken through the center of the 0 degree and 180 degree appendage of one of said SATS is aligned with an axis taken through the center of the 0 degree and 180 degree appendage of an adjacent SATS, and said 0 degree appendage is in contact with said 180 degree appendage of said adjacent cross-shaped SATS, and wherein an axis taken through the center of the 90 degree and 270 degree appendage of one of said SATS is aligned with an axis taken through the center of the 90 degree and 270 degree appendage of an adjacent SATS, and said 90 degree appendage is in contact with said 270 degree appendage of said adjacent cross-shaped SATS, thus forming a square shaped cavity central to said array having an area four times the area of an appendage.

16. The array of claim 15 having a greater stress versus deflection compressive stiffness of at least 20%, relative to a non-SATS control array, beginning at about 20 MPa of stress and continuing to at least about 50 MPa.

17. The array of claim 15 having fracture behavior wherein the fracture appears at a 45 degree angle and spreads through said array in a diagonal direction and through diagonally oriented cross-shaped SATS and travels outside the area of applied force.

18. A method of producing a Self-Assembled Tube Structure (SATS), said SATS comprising an elongate body comprising a plurality of carbon nanotubes, said elongate body having a longitudinal axis and a proximal end and a distal end opposite said proximal end, said proximal end attached to said substrate either directly or indirectly to the substrate by non SATS material, said SATS being either hollow or solid, said SATS being generally symmetrical around said longitudinal axis, said method comprising the steps of:
providing a prepared substrate in a reaction zone
introducing a catalyst into said reaction zone, said catalyst functioning to build said SATS
providing a source of carbon into said reaction zone
providing an atmosphere of shield gas into said reaction zone to keep oxygen away from said reaction zone, and
providing heat to said reaction zone, wherein at least one SATS is produced; wherein prepared substrate is a silicon substrate having channels and towers and is prepared by deep reactive ion etching, said carbon source and said catalyst are combined and are selected from the group consisting of ferrocene and metallocene, and are in solution, said solution being introduced into said reaction zone by atomization.

19. The method of claim 18 wherein said atomization is performed by an ultrasonic device.

20. The method of claim 19 wherein said reaction zone is a tubular furnace and the temperature measured at the substrate is in the range of 800 degrees C. to 850 degrees C. and wherein said shield atmosphere is selected from the group consisting of hydrogen, helium, argon and nitrogen.
